(19) United States
(12) Patent Application Publication
(10) Pub. No.: US 2014/0040715 A1
(43) Pub. Date: Feb. 6, 2014

(54) APPLICATION FOR SYNCHRONIZING E-BOOKS WITH ORIGINAL OR CUSTOM-CREATED SCORES

(71) Applicants: Oliver S. Younge, Indianapolis, IN (US); Leilani M. Harwood, San Diego, CA (US)

(72) Inventors: Oliver S. Younge, Indianapolis, IN (US); Leilani M. Harwood, San Diego, CA (US)

(21) Appl. No.: 13/950,968

(22) Filed: Jul. 25, 2013

Related U.S. Application Data
(60) Provisional application No. 61/675,435, filed on Jul. 25, 2012.

(51) Int. Cl. G06F 17/24

(52) U.S. Cl. CPC G06F 17/24
USPC 715/203

(57) ABSTRACT

An application for electronic devices through which users can synchronize custom sound recordings and sound scores with eBooks. The application allows a computer to receive audio reference lists; values representing how similar users are to each other based on various factors; and a structural representation of an eBook. The application then tracks a first user's position in the eBook, synchronizing the relative position with the structural representation of the eBook, and determining if the first user's position has progressed to a specific point. If the first user has reached the specific point, the application suggests audio that was previously synchronized by other users with the point, and the application orders the suggestions based on the similarity between the first user and a previous user that created a suggested sound score. The first user can then associate a presented audio with the point.

### CROSS-REFERENCE TO RELATED APPLICATIONS

This application claims the benefit under 35 U.S.C. §119(e) of U.S. Patent Application No. 61/675,435, entitled “APPLICATION FOR SYNCHRONIZING E-BOOKS WITH ORIGINAL OR CUSTOM-CREATED SCORES,” filed Jul. 25, 2012, which is incorporated herein by reference in its entirety.

### BACKGROUND

This specification relates to the technical field of software applications. More particularly, the present invention is in the technical field of audio-visual and literature applications.

Printed books have been widely used and disseminated for thousands of years; audio recordings of books, or audiobooks, have existed for approximately a century; and books represented in a digital medium have only been around for several decades. Such digitally-represented books, also known as electronic books or “eBooks,” can be read on digital viewing devices, such as computers. However, the displays of such devices can cause eye strain for the reader.

More recently, to resolve some eye strain difficulties, eBook readers have turned to electronic paper, or e-paper, displays that mimic the appearance of ordinary ink on paper as with a standard print book. Additionally, eBook reading applications and devices have integrated text-to-speech capabilities, allowing readers to listen to a synthesized version of the text instead of actually reading the text directly. However, such applications fail to provide an intimate, traditional experience that many authors envision for their readers and that many readers desire for themselves.

Software applications for merging music and electronic books are indirectly predated by digital music in MP3 and other formats; electronic books stored and accessible on electronic readers; HarperCollins'™ Enhanced E-Books; and BookTracks'™ soundtracks for electronic books. Additionally, the use of social media type websites to promote artistic talent is indirectly predated by services such as Myspace™ and related sites. Web-based applications bringing talent from across the spectrum of music media together with their fans is indirectly predated by services such as Bandpage™.

### SUMMARY

This specification describes technologies relating to an application for user devices such as desktop computers, laptop computers, smart phones, tablets, electronic readers, and the like. The present invention includes, among other features, functions, and capabilities, synchronization of original music scores to existing eBooks or digitally stored audio of books such as audiobooks; a customization function, allowing users to assign their preowned or original music and create custom soundtracks, using their own audio, for their eBooks and literature; and an integration of a web-based social hub devised to bring talent from at least two forms of media—such as books and music—together with their fans. This interaction can occur in a forum designed to promote the discovery of new talent and material across both of the two or more medias and to enable fan interaction, both with other fans and with artists and rising stars, in group and individual settings. This further includes the ability to use social media embedded in the software application to stay connected to or follow the talent and/or artists.

In general, one innovative aspect of the subject matter described in this specification can be embodied in methods that include the actions of, by a computer, receiving sound scores, each sound score synchronized with an eBook, and each sound score comprising at least one audio identifier; receiving a social similarity weight; receiving a linear timeline of the eBook; receiving a user's progression through the eBook; synchronizing the progression through the eBook with the linear timeline; determining if the user has encountered a point of synchronization; if so, presenting the user with a collection of audio identifiers previously synchronized with the point of synchronization; and receiving, from the user, an audio identifier to associate with the point of synchronization. Other embodiments of this aspect include corresponding systems, apparatus, and computer programs, configured to perform the actions of the methods, encoded on computer storage devices.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which the merged media system can exist.

FIG. 2 is a branching tree (akin to a family tree diagram) representing a portion of the data relationships associated with the merged media system.

FIG. 3 is an example of a top view of the logo and icon for the software application implemented in the merged media system.

FIG. 4 is a top view of an exemplar main user interface (UI) of an implementation of the software application implemented in the merged media system.

FIG. 5 is a perspective view of an example of a front (or home) page and primary user interface for the web-based social hub integrated into an implementation of the software application implemented in the merged media system.

FIG. 6 is an example of a Meet the Artist/Author webpage for a selected subgenre.

FIG. 7 is a perspective of an example author webpage.

FIG. 8 is a perspective view of a user discussion webpage.

FIG. 9 is an example user interface for the application after a user has selected either LocalMusic or ApplicationMusic from the main UI.

FIG. 10 is an example of one implementation of the user interface for the application after user has selected either LocalBooks or ApplicationBooks from the Main UI.

FIG. 11 is a perspective view of the UI for one implementation of the invention after a user has selected a particular book from the SlideOut.

FIG. 12 is a perspective view of the UI for one implementation of the invention after a user has selected a Merged Score to synchronize with the selected book from the SlideOut.

FIG. 13 is a perspective view of the UI for one implementation of the invention after a user has selected a custom score to synchronize with the selected book from the SlideOut.

FIG. 14 is a perspective view of the UI for one implementation of the invention after a user has selected a Specialty Sound Score to engage in the merged media system's own interactive music match game, discover/purchase new music, and/or create a custom sound score incorporating some or all of the Specialty Sound Score listed songs.

FIG. 15 is a block diagram of an example computer system that can be used to provide a merged media system and interconnected services.

Like reference numbers and designations in the various drawings indicate like elements.

### DETAILED DESCRIPTION

Before the present methods, implementations and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” an and the include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often, though may not always, occurs, and that the description includes instances where said event or circumstance occurs and instances where it does not.

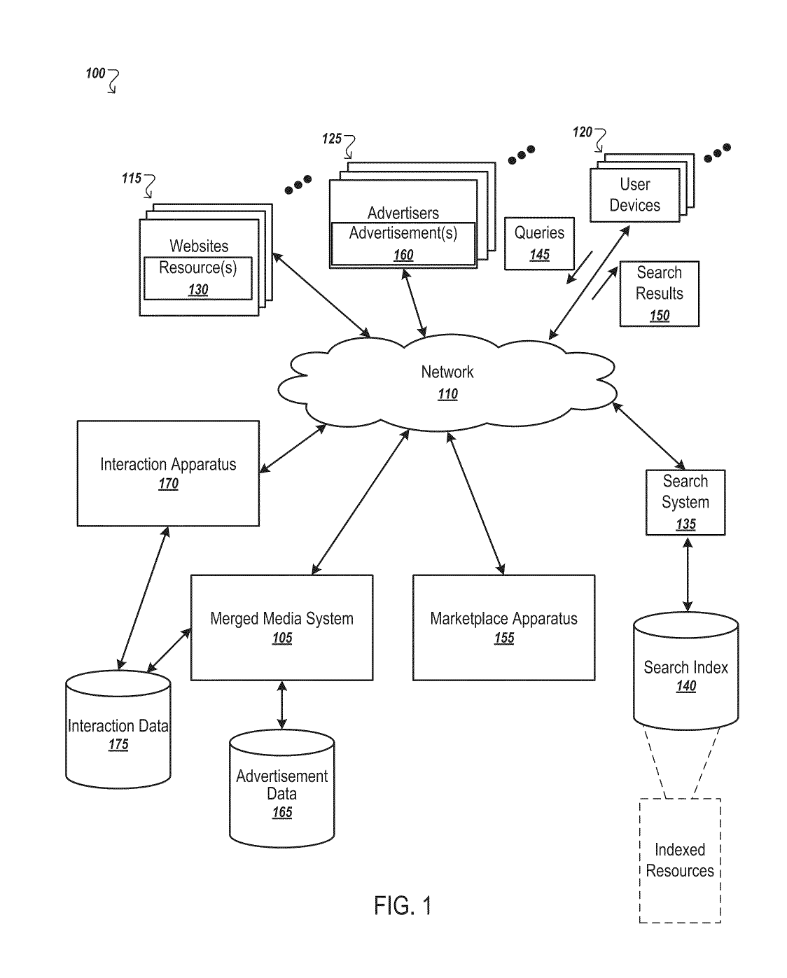

FIG. 1 is a block diagram of an example environment 100 in which the merged media system 105 can exist. For example, the environment 100 includes a merged media system 105 that facilitates social activities between system users, synchronization of different media types for a merged media experience, and customization of currently unsupported media types into a merged media type experience. The example environment 100 also includes a network 110, such as a local area network (LAN), a wide area network (WAN), the Internet, or a combination thereof. The network 110 connects websites 115, user devices 120, advertisers 125, and the merged media system 105. The example environment 100 can potentially include many thousands of websites 115, user devices 120, and advertisers 125.

A website 115 is one or more resources 130 associated with a domain name and hosted by one or more servers. An example website 115 is a collection of webpages formatted in hypertext markup language (HTML) that can contain text, images, multimedia content, and programming elements, such as scripts. Each website 115 is maintained by a publisher, which is an entity that controls, manages and/or owns the website 115.

A resource 130 is any data that can be provided over the network 110. A resource 130 is identified by a resource address (URL) that is associated with the resource 130. Resources 130 include HTML pages, word processing documents, and portable document format (PDF) documents, images, video, and feed sources, to name only a few. The resources 130 can include content, such as words, phrases, images and sounds, that can include embedded information—such as meta-information in hyperlinks—and/or embedded instructions (such as JavaScript scripts). Units of content—for example, data files, scripts, content files, or other digital data—that are presented in (or with) resources are referred to as content items.

A user device 120 is an electronic device that is under control of a user and is capable of requesting and receiving resources 130 over the network 110. Example user devices 120 include personal computers, mobile communication devices, and other devices that can send and receive data over the network 110. A user device 120 typically includes a user application, such as a web browser, to facilitate the sending and receiving of data over the network 110.

A user device 120 can request resources 130 from a website 115. In turn, data representing the resource 130 can be provided to the user device 120 for presentation by the user device 120. The data representing the resource 130 can also include data specifying a portion of the resource or a portion of a user display—for example, a small search text box or a presentation location of a pop-up window—in which advertisements can be presented or third party search tools can be presented.

To facilitate searching of these resources 130, the environment 100 can include a search system 135 that identifies the resources 130 by crawling and indexing the resources 130 provided by the publishers on the websites 115. Data about the resources 130 can be indexed based on the resource 130 to which the data corresponds. The indexed and, optionally, cached copies of the resources 130 are stored in a search index 140.

User devices 120 can submit search queries 145 to the search system 135 over the network 110. In response, the search system 135 accesses the search index 140 to identify resources 130 that are relevant to the search query 145. The search system 135 identifies the resources 130 in the form of search results 150 and returns the search results 150 to the user devices 120 in search results pages. A search result 150 is data generated by the search system 135 that identifies a resource 130 that is responsive to a particular search query, and includes a link to the resource 130. An example search result 150 can include a webpage title, a snippet of text or a portion of an image extracted from the webpage, and the URL of the webpage.

Users that are interested in a particular multimedia product can research the particular product by submitting one or more queries 145 to the search system 135 in an effort to identify information that will assist the user in determining whether to purchase the product or to use currently existing merged media combinations including the product. For example, a user that is interested in merging jazz music with an eBook about the historical progression of jazz music can submit queries 145 such as “jazz,” “jazz progression,” “jazz azz history.” In response to each of these queries 145, the user can be provided search results 150 that have been identified as responsive to the search query—that is, have at least a minimum threshold relevance to the search query, for example, based on cosine similarity measures or clustering techniques. The user can then select one or more of the search results 150 to request presentation of a webpage or other resource 130 that is referenced by a URL associated with the search result 150.

In some implementations, the merged media system 105 can be used to merge two or more media types besides eBooks and audio. For example, the merged media system 105 can merge a custom audio score with a movie file; a comic book, movie trailers, and audio files; a television show with a graphic novel; or any other such media-type combinations. In one such instance, the background music soundtrack for a blockbuster movie can be replaced with a custom audio score at a user's option. This replacement can, in some implementations, allow the user to watch the movie as it would normally be watched—that is, all the video, dialogue, and subtitles can be maintained—while exchanging and/or masking the movie producer's original background music score. Such a replacement operation can be beneficial for displaying of less accessible movies to less attentive audiences—for example, showing La Casa Blanca to teenagers—or when background music contain objectionable content—such as profanity.

When search results 150 are requested by a user device 120, the merged media system 105 receives a request for data to be provided with the resource 130 or search results 150. In response to the request, the merged media system 105 selects product data that are determined to be relevant to the search query. In turn, the selected data are provided to the user device 120 for presentation with the search results 150.

For example, in response to the search query “modern jazz,” the system can present the user with relevant media and products; users that have the relevant media or products in personal collections; or media-specific information webpages. If the user selects—for example, by clicking or touching—the search result 150 the user's device 120 can be redirected, for example, to a webpage containing the product for buy, sell, or interaction on the system. This webpage can include, for example, the author of the media or product; the release date of the media or product; the class, genre, or subgenre of the media or product; or the price of the media or product; and/or other media already associated with the selected media or product.

In some implementations, the returned webpage can include all of the resources 130 that are required to complete the transaction. For example, the webpage can enable the user to add products to an electronic “shopping cart” and enter payment and/or shipping information. Some of these webpages can be secure webpages that protect the users' payment information and/or other sensitive information—for example, the user's address and name. Additionally, the website can include code that completes financial transactions—such as credit card transactions, online payment transactions, or other financial transactions.

In other implementations, the returned webpage can include code that references a marketplace apparatus 155 that is used to complete the transaction. The marketplace apparatus 155 is a data processing apparatus that is configured to facilitate sales transactions between buyers and sellers over the network 110. The marketplace apparatus 155 can be configured to provide electronic “shopping carts,” perform financial transactions, provide transaction confirmation data to the buyer and/or seller, and/or provide shipment tracking information if the user purchases physical goods, such as artist or author merchandise.

For example, a webpage can include code that causes a checkout user interface element—for example, a checkout button—to be presented to the user. In response to the user clicking on the checkout user interface element, checkout data can be provided to the marketplace apparatus 155 indicating that the user is ready to agree to an exchange or complete a purchase. The checkout data can include product identifiers specifying the products that the user has selected to purchase, quantities of each product that the user has selected to purchase, and prices associated with the selected products. These identifiers can be in addition to terms of the exchange or included within the terms of the exchange. In response to receipt of the checkout data, the marketplace apparatus 155 can provide the user with a transaction interface that enables the user to submit payment information and shipping information to complete the transaction. Once the transaction is complete, the marketplace apparatus 155 can provide the user with confirmation data confirming the details of the transaction.

The payment interface that is provided by the marketplace apparatus 155 can be accessed by the user at a secure network location that is referenced by a URL. The URL can be formatted to include data identifying a referring page from which the user navigated to the payment interface. For example, the URL that directs a user to the payment interface can be https://www.examplepaymentinterface.com/—id1234/PartnerA.com, where “id1234” is a unique identifier for Partner A, and PartnerA.com is the domain address for Partner A's website.

The merged media system 105 can also make use of advertisements 160 based on user actions on the website. As a user makes search queries 145 and receives search results 150, the user's activities can be represented in the search index 140 with a session identifier. This session identifier can be the user's Internet Protocol (IP) address, unique browser identifier, or any other similar identifier. Based on the user's interactions, the platform or system can display advertisements 160 from advertisers 125 that target the user's interactions. The determination of relevance based on the user's interactions can also be based upon historical data stored in the advertisement data store 165.

In some implementations, the advertisement data store 165 can also store user interaction data specifying user interactions with presented advertisements (or other content items). For example, when an advertisement is presented to the user, data can be stored in the advertisement data store 165 representing the advertisement impression. Further, in some implementations, the data is stored in response to a request for the advertisement that is presented. For example, the ad request can include data identifying a particular cookie, such that data identifying the cookie can be stored in association with data that identifies the advertisement(s) that was or were presented in response to the request.

When a user selects—for example, clicks or touches—a presented advertisement, data is stored in the advertisement data store 165 representing the user selection of the advertisement. In some implementations, the data is stored in response to a request for a webpage that is linked to by the advertisement. For example, the user selection of the advertisement can initiate a request for presentation of a webpage that is provided by (or for) the advertiser. The request can include data identifying the particular cookie for the user device, and this data can be stored in the advertisement data store 165. Additionally, if an advertiser has opted-in to have click-through traffic tracked, when a user performs an action that the user has defined as a click-through, data representing the click-through can be provided to the merged media system 105 and/or stored in the advertisement data store 165.

In some implementations, user interaction data that are stored in the advertisement data store 165 can be anonymized to protect the identity of the user with which the user interaction data is associated. For example, user identifiers can be removed from the user interaction data. Alternatively, the user interaction data can be associated with a hash value of the user identifier to anonymize the user identifier. In some implementations, user interaction data are only stored for users that opt-in to having user interaction data stored. For example, a user can be provided an opt-in/opt-out user interface that allows the user to specify whether they approve storage of data representing their interactions with content.

When the merged media system 105 and the search system 135 are operated by a same entity, user interaction data can be obtained by the merged media system 105 in a manner similar to that described above. For example, a cookie can be placed on the user device by the search system 135, and the user interactions can be provided to the merged media system 105 using the cookie.

When the merged media system 105 and the search system 135 are operated by different entities that do not share user interaction data as described above, the merged media system 105 can utilize other data collection techniques to obtain user interaction data. For example, the merged media system 105 can obtain user interaction data from users that have agreed to have interactions tracked—that is, he or she opted-in. Users can opt-in, for example, to increase the relevance of content items and other information that are provided to the users, or to obtain a specified benefit such as use of an application or to obtain discounts for other services. As described above, the user interaction data obtained from these users can also be anonymized in order to protect the privacy of the users that opt-in. This user interaction data can also be stored in the advertisement data store 165.

The merged media system 105 can use measures of click-through—or another targeted-user interaction—to determine effectiveness measures for content items that are provided to users. For example, effectiveness of a particular content item can generally be considered to be directly proportional to the portion of all users that interacted with the content item and that are resulting in click-through impressions. These measures of click-through can be used, for example, to adjust advertisement selection algorithms to increase effectiveness of content items that are provided to users. For example, several different advertisement algorithms can be used to select advertisements and click-through rates for each of the algorithms, which can then be compared to determine which algorithm(s) are providing more effective content items—that is, content items having higher effectiveness measures.

As noted above, click-through data may not be available for some content items—for example, because the advertiser has not opted-in to click-through tracking—and click-throughs may not be uniformly defined across all advertisers. Therefore, it can be difficult to evaluate effectiveness of content items by relying only on click-through data. However, predictive interactions can be used to evaluate content item effectiveness, as described in more detail below.

The environment 100 can also include an interaction apparatus 170 that selects predictive interactions with which content item effectiveness can be evaluated. The interaction apparatus 170 is a data processing apparatus that analyzes target interaction data and prior interaction data, for example stored in an interaction data store 175, to identify those prior interactions that are performed, with at least a threshold likelihood, by users prior to performance of the target interaction. For example, the interaction apparatus 170 can determine that users searching for a certain type of frequently mistyped product—for example, “Song of Fire and Ice”—mean to search for a different term—such as “Song of Ice and Fire. If the interaction apparatus 170 can determine that a threshold portion of all users committed this error, it can suggest or redirect to the correct search by default as a predictive interaction for the search.

In some implementations, the interaction apparatus 170 can also determine that the portion of all users that performed a predictive interaction, but did not perform the target interaction. The interaction apparatus 170 can use this determination as an indication of the false positive rate that can occur using the predictive interaction as a proxy for the target interaction.

Once the interaction apparatus 170 selects the predictive interactions, the interaction apparatus 170 determines whether additional user interaction data include predictive interaction data. The additional user interaction data can be user interaction data that do not include target interaction data. For example, the additional user interaction data can be user interaction data for user interactions with a website for which click-throughs are not tracked. When the interaction apparatus 170 determines that the additional user interaction data include the predictive interaction data, the user from which the user interaction data was received can be considered a click-through user for purposes of determining content item effectiveness.

In some implementations, the interaction apparatus 170 can assign each click-through user a weight that represents the relative importance of the click-through user's interactions for computing content item effectiveness. For example, a user that performs many different predictive interactions can have a higher weight than a user that performs only one predictive interaction. In some implementations, the interaction apparatus 170 can assign a same weight—that is, 1.0—to each click-through user. This concept can be used to more accurately correlate and suggest multimedia content to users. For example, the system can associate two users that listen to the same artists from the same genre, and that read the books from the same author in the same genre, and suggest new interests that one user discovers that the other user has yet to discover. Additionally, the system can give greater weight to a user that more closely correlates to another user. For example, if user A has ten artists and five authors in common with User B, and five artists and ten authors in common with User C, the system can suggest artists to User A based on the increased correlation for artists with User B, but suggest authors to User A based on the increased correlation for authors with User C. Other correlation methods can also be used, such as cosine similarity measures, clustering techniques, or any other similar technique.

Further, in some implementations, the interaction apparatus 170 can be used to determine a social similarity weight, which is a value representing a social similarity between a first user and a second user based on a multitude of factors including, but not limited to, number of shared authors or artists, frequency of interaction with system, etc. For example, if User A shares twenty artists or authors in common with User B but shares one hundred artists or authors with User C, then User A can be assigned a higher social similarity weight with User C than with User B. In some implementations, the factors affecting the social similarity weight can be given equal weight, while in other implementations the weight given to each factor can vary based on some subjective or objective weighing scheme. In some implementations, suggestions can be given to a user based on the social similarity weight, among many other possible factors. For example, matching a user with another user for some purpose on the system can use the relative social similarity weights to rank users higher or lower on lists. Additionally, social similarity weights and suggestions can be made based on, but not limited to, the number of currently owned media titles, location, age, etc.

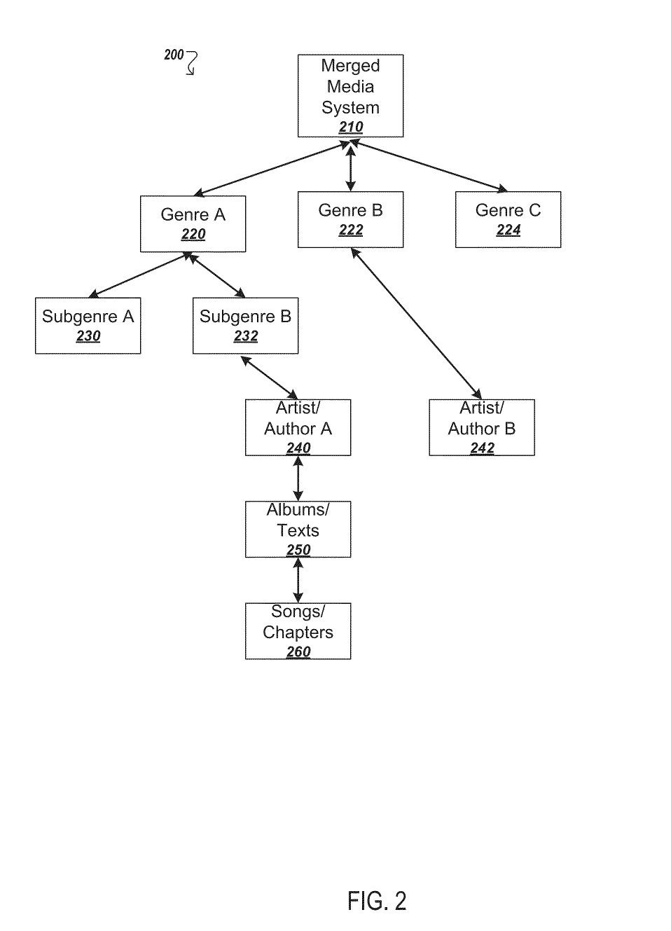

FIG. 2 shows a branching tree 200 (akin to a family tree diagram), with boxes located on the various branches of the tree. Each box corresponds to a data relationship. For example, FIG. 2 shows the Merged Media System 210 (also 105) connected to Genres 220, 222, 224; further connected to Subgenres 230, 232; further connected to individual artists/authors 240, 242; further connected to an individual artist/author's albums/texts 250; and finally connected to individual songs/chapters 260 within the albums/texts 250. The data relationships can be stored in databases on the service provider's cloud, networked and/or physical servers.

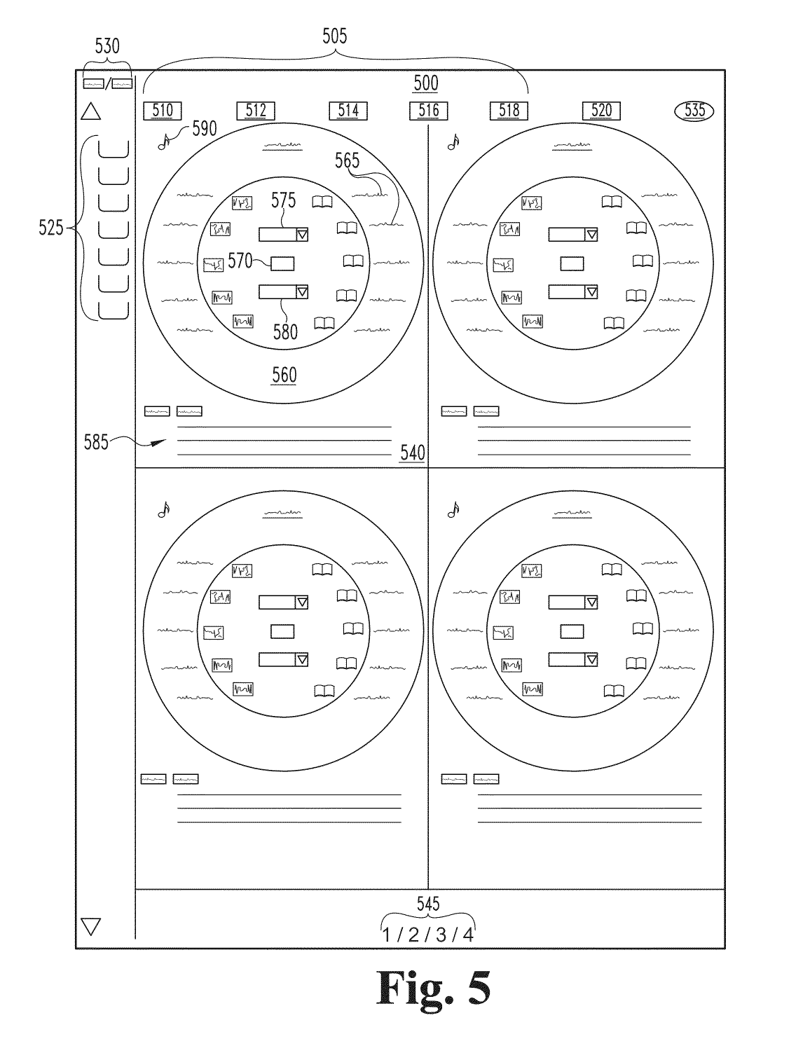

In some implementations, all of the databases underlying the various webpages can be associated with and able to be viewed and accessed on the system's social hub 500. In effect, FIG. 2 shows the construction of the system's social hub components, including visual and functional and underlying design aspects of the invention as shown in FIG. 5.

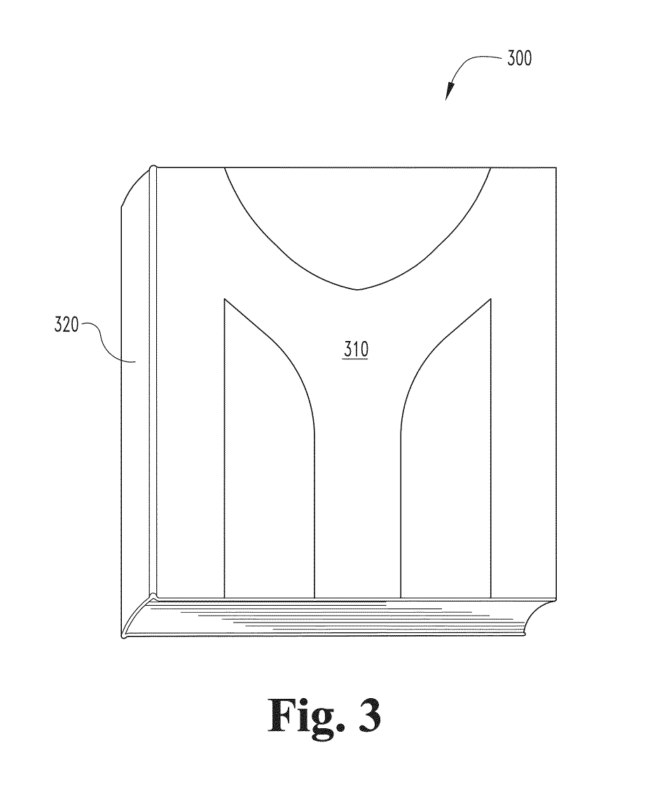

FIG. 3 is an example of the icon/logo for one implementation of an application in the shape of a closed, three-dimensional book 300, with the letters Y and M intersecting each other on the front cover 310—indicative of a Company's trademarked name—and the trademarked name of the application on the spine 320. The application's trademarked name is undisclosed here.

In some implementations, the icon/logo screen displayed in FIG. 3 can provide the login interface for the application. For instance, clicking on the icon/logo can trigger a pop-up window event in which the user can enter their username and password credentials. Alternatively, the credential entry field can exist as an inset field of the icon/logo screen. For example, a field with two individual box fields, marked “Username” and “Password” respectively, can appear on the upper-right of the icon/logo screen and allow the user to login. In some other implementations, the user's login credentials can be saved and/or automatically populated the user device. For example, the application can save an initial entry of user credentials to be used again in the future, or the application can request a common password string from the user's password database, such as a key-ring application that can automatically generate passwords for entry without the user's command.

In some implementations, the application can also allow the user to immediately launch the application after installation and certain administrative actions can be triggered upon the user's download and use of the application. For example, a user prompt can request and/or require the user to register with the service provider. Requested or required information can include name, email, and/or billing information. The user can also set up his or her profile at this point in time, entering a username and password. Other user preferences, such as notification type and frequency, library storage location and limits, and depth of media search performed by the application can be set up or assigned. Initial tests can also be run by the application to better define aspects of user interaction. For example, the application can administer a test to determine the user's reading speed or to set up voice commands given or received by the application.

Further, in some implementations, the icon/logo screen displayed in FIG. 3 can indicate certain aspects of the user's interactions on the application's social network. For instance, the icon/title can pulse with certain colors depending on amount of recent interactions on the social network or the immediacy of an upcoming event (for instance, a personal chat with a favorite artist or author). Further, in some implementations, the application can also display urgent reminders, such as a scheduled interview with an artist or author, on the icon/logo screen in, for example, a message bubble. The bubble itself can additionally change colors to represent the level of urgency. In some additional implementations, the application can also provide a sensory reminder on the user device to denote such events. For example, the user device can perform an auditory chime, a tactile feedback such as a vibration, a visual flashing such as by a smartphones indicator light, or any other similar functions. In some implementations, the application can recognize a user without the user having to log in, for instance through the use of cookies.

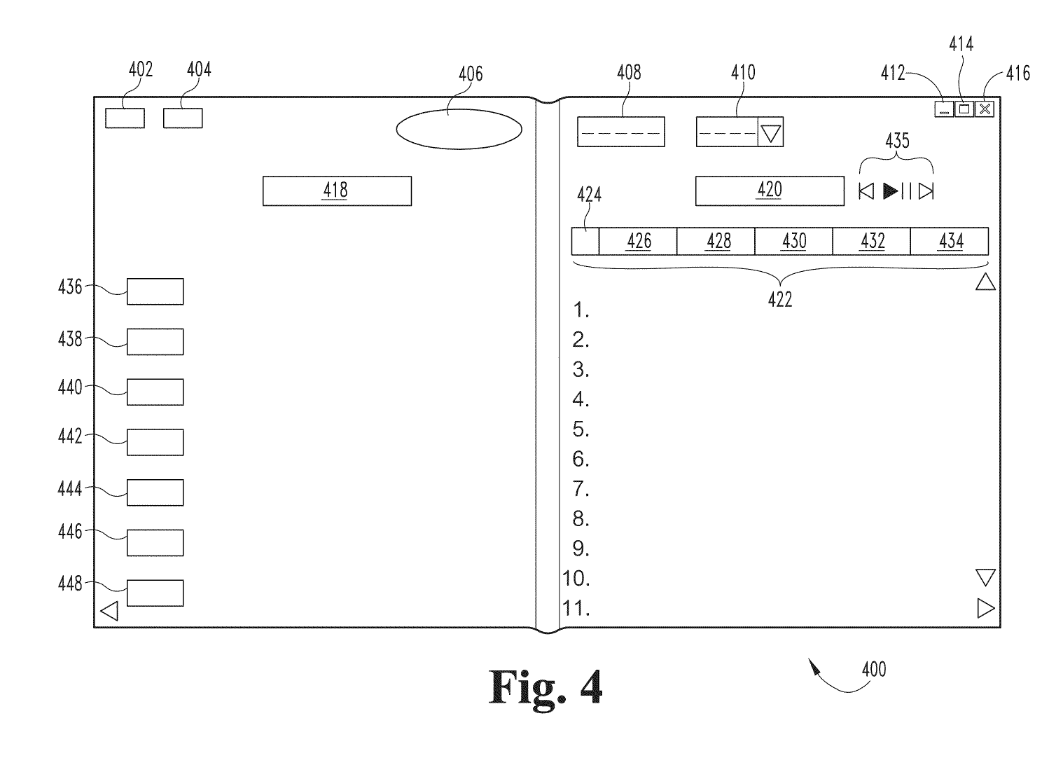

Referring now to an example of an implementation depicting the transition between the icon/logo 300 of the application and the main user interface (UI) 400, the application opens by double-clicking the closed-book logo/icon 300. The application is accessed, in some implementations, by double-clicking—either with a mouse or using a finger to double tap on devices with touch-screen interfaces—on the logo/icon, and the transition into the main user interface 400 is in the form of an animation showing the closed book opening into an open book shape, on which all functional components of the application are laid out. (FIG. 4).

Referring to one possible implementation of FIG. 4, there is an example depicting the application in the shape of an open book 300, with multiple tabs (and two uniquely shaped buttons or icons), placed on the top and left-side, a music player/viewer, two ticker-styled scrolling windows and several window screens. In some implementations, this portion of the application is for synchronizing eBooks and music, discovering and interacting with new authors and artists and their work, and other fans, and sampling and purchasing new print or music media.

An eBook, for the purposes of this application, is a story and/or book that exists in a digital format. The eBook can derive from material or materials that were initially published in a physical, print medium—such as The Divine Comedy by Dante Alighieri—or it can be initially published in a digital, eBook format. In some instances, the eBook can also derive from audio recordings, such as a spoken narrative; sensory-aid materials, such as Brail markings; or any other convertible format. An eBook can also contain additional media resources such as pictures or video. Further, an eBook can be associated with a particular device, such as the Amazon Kindle, or it can be a general file type, such as .txt, that is readable on most digital devices. In some implementations, the underlying eBook format can also contain connection elements to synchronize with resources outside of the eBook. For example, the Kindle eBook can communicate over a network to retrieve additional multimedia resources or record information about the user's reading status and habits.

Referring still to FIG. 4 in more detail, in some implementations, the following buttons or tabs are always visible on the application's UI. In some other implementations, the tabs and/or buttons are context sensitive and appear to the user based upon the user's actions and/or history of interaction with the application. These tabs or buttons being not limited to, but consisting currently of, the following described buttons:

Referring again to FIG. 4, a Menu tab 402 is shown that has, in some implementations, a dropdown feature, which exposes several other tabs, including Options, Toggle Custom Sound Score, Open, Import, Mute, and Account Management. On the smart phone version, Menu is accessible from device's own menu button.

Referring yet to FIG. 4 in greater detail, there is shown a Help tab 404, which is a small tab that has a drop down feature exposing a Tutorial tab and a Contact Us tab. In some implementations, the Help tab 404 has a drop down feature that, using context of the user's actions and the interaction apparatus 170, provides drop down tabs exposing predictive helpful content and instructions. In some implementations, the Tutorial accesses a .txt file that is stored on user's selected storage upon install, and displays a complete Manual. In some other implementations, the Tutorial accesses dynamically composed content, for example a Manual containing user-composed examples. In those implementations, the dynamically composed content can be generated at will, for example, from online storage content.

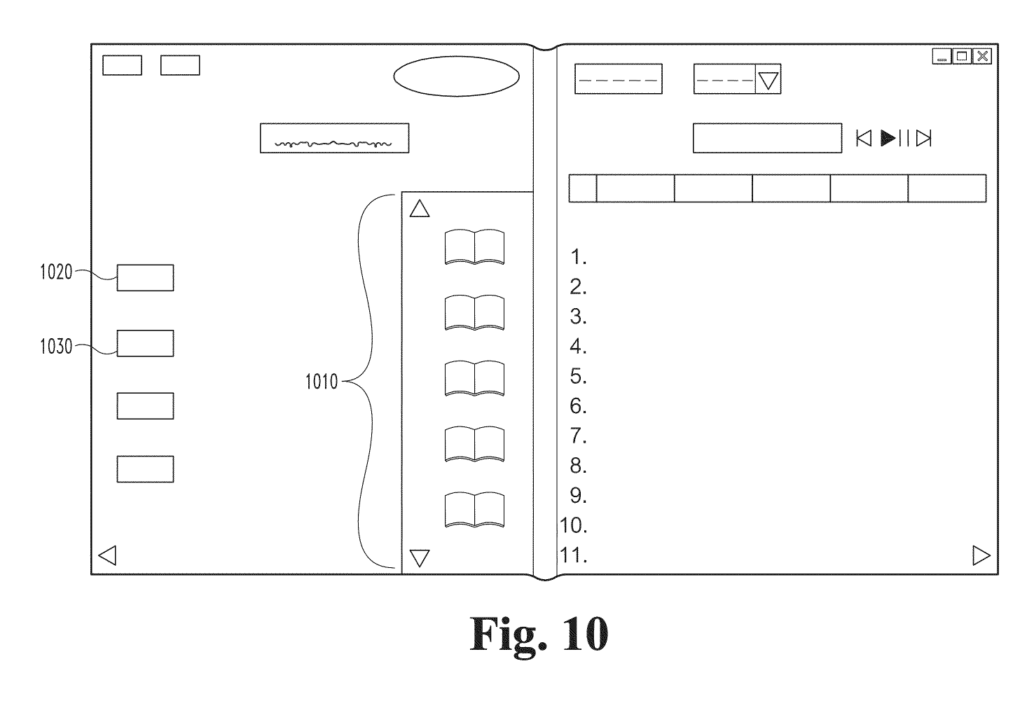

Referring yet to FIG. 4 in greater detail, there is shown a Search Window 306 which is oval, but can be outlined in any shape, that allows a search for any song or book title and displays results in the Viewer. Songs can be immediately played from Player. A book that is searched for will show up in the SlideOut 910 (also 1010) section of the application, with all of its Sound Scores, Specialty Sound Scores, and/or merged score (if owned) underneath it, the same way selecting that particular eBook from the LocalBooks or ApplicationBooks screens can do, as described below in reference to FIG. 10.

In some implementations, the Sound Score is a listing of one or more audio identifiers that can be associated with points of synchronization. For example, the Sound Score can be composed of ten audio identifiers, each audio identifier being associated in some way—for example, a programmatic call to an internal data store, an external call to an external data store, or any other type of association—with at least one file capable of producing sound. The audio identifiers can, for example, reference a .mp3 file stored on the system's cloud storage or a .wav file stored on a user's local hard drive or solid state drive. Thus, the Sound Score can link ten audio identifiers with ten points—points of synchronization, described elsewhere in this application—in the eBook.

In some implementations, Sound Score songs can be played according to the pace of the user. For example, if the user reads faster than the Sound Score creator anticipated for a specific scene-song combination, the system can modify the synchronization to compensate. Thus, the system can, for example, crossfade between songs as a user reaches the next trigger point, instead of allowing the songs to naturally end. Oppositely, the system can also recognize a slower user's pace, compensating by, for example, looping all or part of the song until the user reaches the next trigger point. Further, in some implementations, the system can recognize the mismatch between the Sound Score and the user's pace, making suggestions based on the recognition. For example, if the user is consistently faster than the expected pace, causing repeated crossfades, the system can suggest to the user a Sound Score made specifically for faster readers. The system can also make suggestions based on the actions of other users who fit a similar trend. For example, if most other quick-reading users switched to a specific Sound Score, the system can suggest that Sound Score for users it determines to be fast readers. The system can also make such recommendations based on stored information of users. For example, if the system classified a user as a fast reader for the past several texts read, the system can automatically suggest that the user select a certain Sound Score listed as being for fast readers or frequently chosen by fast readers.

Tracking of a user's progress—or progression—through the eBook can occur through various methods. Progression, in one simple form, can be considered the user's reading through an eBook at a pace such that the system takes note when the user encounters a point of synchronization. In another example, the system can track progression by recording changes in the active page being displayed to the user. The system can also record the time between those page changes and determine the time spent reading per page, and/or the words per minute that the user achieved. In some implementations, the system can track the progress of the user by a user's interaction with various elements of the text. For example, if a user clicks or touches a part of a page, zooms into a particular portion of a page, highlights a portion of text, or makes a digital annotation, the system can record this as the user's current position.

Additionally, in some implementations, the user's progress can be recorded by tracking the user's eye patterns or vocalizations. For example, the user's eye movements can be tracked by a camera—such as a laptop or smartphones integrated camera—to determine the position of where the user is reading. In other implementations, the user's vocalizations—that is, reading aloud as they progress through the text—can be recorded and cross referenced with the text to determine the user's current progress. This tracking can also be used to help determine the user's reading speed. For example, analysis of the user's reading speed can use the user's ocular, vocal, or tactile interactions with the user device to determine the user's rate of progression through the eBook. Further, in some implementations the analysis of the user's reading speed using the user's ocular, vocal, or tactile interactions can take into account diversion of the user's attention, modifying the reading speed calculation to account for the diversion. For example, if a user is reading aloud and then stops to chat with his or her family member, the system can recognize that the user is no longer reading the eBook—for instance, by comparing the number of incorrectly spoken words compared to the expected eBook words in a given period of time—and then exclude the time period spent conversing with the family member from the time used to calculate the user's words per minute calculation. When tracking the user's interaction with a user device through ocular interactions, the system can, for example, make use of laser scanning, a user device's camera, or any other device able to track a user's eye movement. If the application determines that the user has diverted their gaze from the screen, or has otherwise lost focus on the reading task, the application can take into account this period of inattentiveness as described above with verbal interactions.

The system can, in some implementations, make use of optical character recognition (OCR), to determine aspects such as words per page, the specific word being vocalized, or the specific word being read by the user's eyes. For example, the system can determine a user read a page of 500 words in 50 seconds, meaning the user read at a rate of 600 words per minute; or that the user is currently reading “All hope abandon, ye who enter here,” which is located at the bottom of the current page that the user is reading. In some implementations, these tracking features can enabled or disabled by the user for privacy and/or regulatory compliance. Further, either of these tracking methods can be used to determine a user's pace through the text, modifying synchronization and presentation of content as described previously.

In some implementations, OCR can be used to generate a linear timeline—a chronological representation of the eBook at a level sufficiently detailed to enable synchronization of a sound score with the contents of the eBook—for the system to use during synchronization and user-locating tasks. For example, the linear timeline can break an eBook down by chapter, page, or other reasonable divisions—assigning relatively linear values that increase as the divisions increase—such that each division can be individually identified. In some implementations, these unique divisions can be the points of synchronization—described elsewhere in this application—that can link an audio identifier with a particular scene or range in the eBook.

In some implementations, the system can also provide feedback to the user for performance with regard to impairment—such as reading, speaking, or otherwise. The system can, for example, inform the user that the user's reading speed has increased over the recorded use of the application; display a notice when the user pronounces a word incorrectly, optionally providing the user with the correct pronunciation; and/or suggest texts or Sound Scores that allow the user to incrementally improve his or her impaired ability with increasingly difficult text.

Referring yet to FIG. 4 in greater detail, there is shown a Feed Window 408. In some implementations, the Feed Window 408 is a scrolling ticker within a rectangular window displaying information relating to Online Store updates, such as updates to the website, new music or books added to the site, etc. In some implementations, the Feed can be a link to a URL relating to a specific “New On [Merged Media System]” page on the Online Store.

Referring yet to FIG. 4 in greater detail, there is shown a Follow screen 410. In some implementations, the Follow screen 410 is implemented as a rectangular window that has a small drop down inverted triangle within its right edge. The drop down shows any artists or authors that the user is “Following.” In some implementations, the user can choose to follow specific authors or artists that are on system's social hub by selecting Follow on those artists or author's home pages. In some of these implementations, the Follow screen 410 integrates Twitter™, Facebook™, or like social feeds/updates into the application, allowing authors/artists followed by the user to have their updates show up in the Follow Window 410, assuming the user has the respective social media accounts. In some other implementations, the artists/authors can push messages to their followers through the application to all the linked social networks.

Referring yet to FIG. 4 in greater detail, there is shown a small button in the shape of a “minus” sign, which refers to a Minimize button 412. In some implementations, the application minimizes to a single bar that sits vertically to the right of the user's device. The bar is translucent enabling viewing of what lies below the bar, as are any buttons or tabs displayed on the bar in any implementation of the application. The bar can, for example, have two components. The top 20 percent can be a miniature controller with frequently used features/functions of the application, such as the mute button and the Toggle Special Sound Score button. The bottom 80 percent can be a string of button having numbers therein relating directly to the slots in the Player corresponding to the eBook being read. The bar allows the user to quickly execute common commands and to inform the application of his or her current position. Further, in some implementations, the bar is only visible while being interacted with. For example, the bottom 5 percent of the bar can be a square. Further, when the user touches the bottom right corner to initiate the sliding action that turns the page, he or she can touch the square and slide it to the left, informing the application that the reader is progressing to a successive page and that it should skip to the next loop or track if the next page enters a successive page range corresponding to a new score track. If reading in landscape, the slide action to turn the page can inform the application that the reader has gone forward two pages. Additionally, the application can have the devices use standard numbers, which do not change when font size or spacing is changed. Thus, multiple, successive pages on a small screen can show the same page number, and only the content displayed is of consequence to the application's location determination.

If the user so chooses, he or she can interface with the application without viewing the entire application, and therefore mute music, change songs, or custom sound scores on a whim. One such interface example is the vertical bar described in the previous paragraph. Some implementations enable the use of voice commands to navigate the interface. Voice commands and partial interface interaction can allow users to toggle certain controls of the application, such as switch between custom soundtracks for the eBook being read. In some implementations, after a period of time of not being touched, for instance two seconds, the transparent bar disappears.

The way the application minimizes, the Toggle Custom Sound Score menu item, and the Slot functionality, taken together, can allow seamless integration and reduction of the user's reading process. Further integration is facilitated by more efficient toggling between custom sound scores. In some implementations, the interface can learn the user's pattern of commands relative to the context of the user's action, for example through use of the systems interaction apparatus 170. Such implementations enable the interface to predict menus and highlight likely user commands. In such implementations, the learning of the user's pattern of commands relative to a context of the user's actions can be accomplished through standard machine learning techniques. For example, since a user will ultimately select his desired interface command, supervised machine learning techniques such as back propagation, random forests (multitudes of decision trees), Bayes classification, multilinear subspace learning, and statistical relational learning can be used to train the interface. In some of these implementations, the learning is supplied contextual information such as the category of the digital book, the age of the digital book, the category and/or type of music and the like. The contextual information can be used to help refine the training information for the learning algorithm. For example, a user reading a textbook is more likely to make use of the pause and backup functions than a user reading a romance novel.

To illustrate the advantages of the application's design for the function of merging books with music, consider, for example, a compact disc changer with 6 CDs. If a person were listening to the 7^{th} song on the first CD, and decided to listen to the second CD instead, one push of a button could change the cd being played in the player, and the newly selected cd would start from the first song on the disc.

Now consider the application described by the present invention. The application allows a person to create as many custom Sound Scores as desired, for synchronizing with any one particular book. A person's first custom sound score can have song X slated to play 7^{th} (and thus aligned and synchronized to the 7^{th} scene in the book being read), while the second or Nth custom sound score has song Y slated to play 7^{th}.

Thus, if a user is reading the Red Badge of Courage while listening to his or her first custom sound score, and upon getting to scene 7, decides that he or she would prefer to hear the tune from the second custom sound score while reading that particular passage, selecting Toggle Custom Sound Score—for instance from 402 in FIG. 4—would allow the user to immediately switch to another list. Since the particular song being played by the application's player solely depends on—and is always synchronized to—the reader's location in the book, then upon switching to a second custom sound score the desired song would immediately begin playing.

Referring yet to FIG. 4 in greater detail, there are shown two small buttons, one in the shape of a small square and the other in the shape of an “X”, 414 and 416 respectively, which refer to maximize and close buttons whose functionality are familiar to users.

Referring again to FIG. 4 in greater detail, there is shown a Now Viewing Window 418, a modest-sized rectangular window centered on the “left side” of the application and taking up approximately 50 percent of the diameter of that side, which serves multiple functions. In some implementations, the Now Viewing Window 418 displays the main tab or feature that the user is viewing such as “LocalBooks” or a selected book. Additionally, in some implementations, the Now Viewing Window 418 also acts as a gauge that fills with color relating to a percentage meter that is tied to the application's Specialty Sound Score Interactive feature, described further below.

Referring still to FIG. 4 in greater detail, there is shown a Display Window 420 that, in some implementations, scrolls information relating to specific song being played such as artists, author, time, etc., and which is represented as another modest-sized rectangular window centered on the “right side” of the application and taking up approximately 33.33 percent of the diameter of that side.

Referring yet to FIG. 4 in greater detail, there is shown a series of rectangular tabs underneath the Display Window 420—the total number of tabs not limited to the number shown—which refer to the main View Categories 422 that a user can use to display information relating to songs in the Player, such as Name, Artist, Genre, etc. In some implementations, an additional tab is also displayed that includes similar information but pertaining to artists, genres, etc. that are similar to the songs, artists, genres in the player.

Referring more specifically to the buttons shown on the application and designated as View Categories 422, briefly described above, these buttons can have various different labels corresponding to categories and functions necessary to organize or manipulate the information being displayed in the Player/Viewer. The View Categories 422 shown are not to be considered limited to, but include the following: Slot, Name, A/C, Album, Genre, and Time. The View Categories 422 herein described as subdivisions of 422 can serve the following basic functions, along with any other functions not described but within the same spirit and scope of the invention as claimed:

Slot (424) refers to a set of locations on the Player marking the “place in line” for songs or books in the list being viewed or manipulated in the Player. “Name” (426) displays a song or piece title. Internally, the application relates any title to the slot in which it sits, and obeys a preset command to play that title for as long as the user remains in the preset scene (page or location range). The specific range or scene can be called, for example, a point of synchronization. The points of synchronization identify at what point in the eBook's linear timeline—described elsewhere in this application—that an audio file will play as the reader progresses through the eBook. Thus, the process of synchronization can be considered, for example, to be the linking of the user's current progression through the eBook on the linear timeline with audio identifiers, arranged by a Sound Score, such that the audio identifiers are triggered to execute as the user's progress enters within the points of synchronization; however, this is not an exclusive explanation of a possible synchronization process. In some implementations, the points of synchronization can appear at specific chapters, pages, or even paragraphs. For example, the composer of a Sound Score can link Song X to being playing at Chapter 2, or Page 30, or paragraph 400; however, other ways can obviously be used to obtain such synchronization and triggering.

In some implementations, the slot numbers correspond to numbers shown in the transparent sidebar, which is accessible to the right of the user's device when the application is minimized. Music for each page range tied to a specific slot plays in a loop until the user is no longer within that page range. The application identifies reader location so that the correct slot (and corresponding page range and music loop) is cued, in a number of different ways. In some implementations, interaction with the sidebar, as described elsewhere herein, is sufficient to identify user placement for the purpose of synchronizing music to the user's reading. In other implementations, the application can utilize OCR technology to “see” what the reader is looking at, using this data to cue the correct slot and music. In some other implementations, device manufacturers and/or device users can give permission to the application to directly obtain information as to what page a user is reading, for example by sending data relating to the location number used by certain device makers to the application. “A/C” (428) shows the name of artist or composer responsible for creating the song or piece showing in the Title area. “Album” (430) displays the name of the album from which the song being viewed in the title is derived. “Genre” (432) displays the accepted genre group or association for the song or album being viewed, for example Rock, or Reggae. The genre displayed is the most accurate subgenre, not the overall genre—such as Indie Rock would be shown instead of the more general Rock—and these groupings correspond to system's social hub subgenre Wheels (see 540). “Time” (434) displays the total length of time for playback of the song or piece showing in the Title area.

Still referring to FIG. 4 in more detail, there is shown a series of indicators that resemble symbols on typical music players designated as Player Controls 424. Player Controls 424 refers to the Player's controller buttons, allowing a user to select to play the selected song, pause the current song, skip the current song to another song, etc. In some implementations, a button can allow for the activation of voice control or commands allowing for hands free interaction with the application.

Referring to FIG. 4 in more detail, there is shown multiple vertically-aligned tabs on the left edge of the application described in FIG. 4, numbered from 436 through 448. Each of the tabs shown operate important functions within the application, and when accessed by double clicking or touching, execute preset commands—and each tab, when accessed, displays both information, and subtabs, all of which are described in greater detail in this application.

Referring to FIG. 4 in greater detail, 436 refers to a tab that can be inscribed with Social Hub—or words of similar meaning or implying the same function as that herein described. The Social Hub 436 redirects user to the interactive social hub page of the system's Online Store or Marketplace, which can be viewed in external browser or within the application itself.

Unknown artists typically struggle with marketing and promoting their products. Consumers are sometimes forced to find these artists' content and/or websites individually. In some implementations, the software application's interconnected, web-based social hub will offer an avenue where those artists and their products can receive greater visibility. This social hub can also provide a wider array of choices for users due to the lower barriers to entry and increased ability to associate content with users.

Referring to FIG. 4 in greater detail, 438 refers to a tab that can be inscribed with the name LocalMusic—or words of similar meaning or implying the same function as that herein described. LocalMusic 438 displays all music files stored in any folders user designated, within the SlideOut 910. Internally, the command can be to search all file spaces including direct and cloud based for audio and visual files such as files of the formats of mp3, .m4a, .aac, .mpg, .mpeg4, and the like.

Referring to FIG. 4 in greater detail, 440 refers to a tab that can be inscribed with the name ApplicationMusic—or words of similar meaning or implying the same function as that herein described. ApplicationMusic 440 displays all music files stored in ApplicationMusic Folder created by the application on installation to house music downloaded from system's social hub and displays them within the SlideOut 910. In some implementations, this executes a command to search ApplicationMusic for files such as files of the formats of .mp3, .m4a, .aac, .mpg, .mpeg4, and the like.

Referring to FIG. 4 in greater detail, 442 refers to a tab that can be inscribed with the name LocalBooks—or words of similar meaning or implying the same function as that herein described. LocalBooks 442 displays all electronic book files stored in any folder user designated and displays them within in the SlideOut 910. In some implementations, this executes a command to search all file spaces—including direct and cloud-based—for .pdf, .epub, .mobi, etc.

Referring to FIG. 4 in greater detail, 444 refers to a tab that can be inscribed with the name ApplicationBooks—or words of similar meaning or implying the same function as that herein described. ApplicationBooks 444 displays all electronic book files stored in ApplicationBooks folder created by the application on installation to house electronic books downloaded from system's social hub and then displays them within the SlideOut 910. In some implementations, this executes a command to search ApplicationBooks for .pdf, .epub, and/or other similar file types.

Referring to FIG. 4 in greater detail, 446 refers to a tab that can be inscribed with the name Specialty Sound Score—or words of similar meaning or implying the same function as that herein described. The software application and the interconnected social hub website provide new avenues for ensuring that the artists and their works get discovered. One such example is the Specialty Sound Score Interactive Feature and the associated Specialty Sound Scores.

Specialty Sound Score 446 displays a full list of special sound scores—which can be called, for example, Preferred Sound Scores, Specialty Sound Scores, or some other title denoting its desired status—that the application's users will have been able to download from the system's online store, accessible directly via the application's interface. The Specialty Sound Scores are stored in the appropriate subfolder (by eBook title) of ApplicationBooks created by the application—upon installation for eBooks already owned, and upon startup of the application for all new eBooks or Specialty Sound Scores added—and then displayed within the SlideOut 910. In some implementations, this executes a command to search ApplicationBooks for .docx, .epub, .txt, etc.

Specialty Sound Scores introduce users to artists and music sold on system's social hub and associated content sites. This can also provide a more efficient method of advertisement than traditional advertisements. For example, advertising to a wide audience over a centralized, digital medium is relatively cheap and virtually instantaneous, while stapling flyers onto telephone posts across the country is demographically limited, expensive, and time consuming. In some implementations, Specialty Sound Scores are designed to be evolving and specific-user targeted by allowing both manual creation and automatic generation based on specific consumers' choices made in editing downloaded Specialty Sound Scores and/or creating their own custom sound scores. For example, a user can go through the process of synchronizing an eBook with audio identifiers, receiving suggestions on media to synchronize—for example, by social similarity weight—and manually generating the new custom Sound Score; however, the system can also automatically initiate, match, and recommend a system-generated custom Sound Score to the user. Here, for example, the system can note that a particular user is interested in reading Pride and Prejudice, and that the user typically listens to smooth jazz, and then the system can generate and recommend to the user a custom Sound Score for Price and Prejudice with smooth jazz pairings. These aspects ensure that user experiences can be unique as each successive automatic generation and download of Specialty Sound Scores will continuously feed the content customization information for both that particular user and, ultimately, all other users that the system associates with that user due to that consumer's music tastes and preferences.

Referring to FIG. 4 in greater detail, 448 refers to a tab that can be inscribed with the name Favorites—or words of similar meaning or implying the same function as that herein described. When a user clicks on the Favorites tab 448, the application can display various saved, or “favorited,” items such as, but not limited to, other users that the user enjoys interacting with, favorite artists or author of the user, and/or the like.

Referring now to FIG. 5, there is shown a website that is part of the system's Online Marketplace, which is called Social Hub (or something of a similar nature or function). The website, Social Hub, has several features and functions that are tied to the application, and on some devices, the website will be able to open within the user's device. In some implementations, Social Hub can open in a separate browser.

Referring to FIG. 5 in greater detail, 500 refers to a spot at the top of the website to which the Social Hub tab 436 directed user, wherein is displayed the name of the website, which can be called Social Hub or any other name that can be trademarked—the site itself shares interaction with a user socially oriented marketplace.

Social Hub allows for social networking, with a focus on music and literature interactivity. The Social Hub Wheels 540 display a number of artists and authors linked by common themes, including similarity between genres, subgenres, or a complementary “vibe” to the constituent works, and can allow discussion of the works by artists or authors on Social Hub. Some implementations of the application and interconnected web-based social hub incorporate a web-based radio function and/or streaming media function, whereby music from artists on one or more wheels is streamed directly to users of the application. For example, book trailers or other media connected to authors' works can be streamed to the users. Such streams can be organized into wheel streams, similar the organization of other media. Similar to the organization of other media, wheel streams can be divided up into different (radio) stations or streams based on a particular genre or subgenre, or on some other factor. The streaming media provides additional connection between the merged media application and the connected web-based social hub. Additionally, streams can allow advertising opportunities for the artists or authors. For example, an artist could have a stream for his music that occasionally promotes an upcoming tour for the artist.

Referring again to FIG. 5 in more detail, there is shown a page with several top-side and left-side tabs, and the main page consists of four Social Hub subgenre Wheels 540—concentric circles in the shape of wheels without spokes—within and around which are multiple buttons, icons, and indicators.

Referring to FIG. 5 in greater detail, there is shown an example of an implementation utilizing a website with horizontally outlined tabs at the top and vertically outlined tabs to the left, and four separate pages—arranged 2×2—each of which is dominated by a Wheel sitting on top of three lines, and within and surrounding which are several icons, indicators, windows, buttons, tabs, and lines.

Referring to FIG. 5 in greater detail, there is shown a horizontal string of tabs 505, whose titles correspond to either known book or music genres. In some implementations, each individual genre tab—for example, 510, 512, 514, etc.—accesses a database. Such implementations can utilize genre database where each genre databases houses multiple subgenre databases. (See FIG. 2). Selecting any genre tab—for example, 510, 512, 514, etc.—initiates a search function, causing a search for and display of all subgenre database titles on the left side of the webpage. In some implementations, the search function is prepopulated with parameters derived from past user actions and selections, which can be determined, for example, through the interaction apparatus 170. Within the horizontal string of tabs there is also shown an Application Wheels tab 520, which represents allow users to dictate which Wheels, from a variety of genres, can be displayed on their screen. Selection of Wheels for the Application Wheels function is performed by the user selecting specific symbols, described in greater detail at a latter portion of this application.

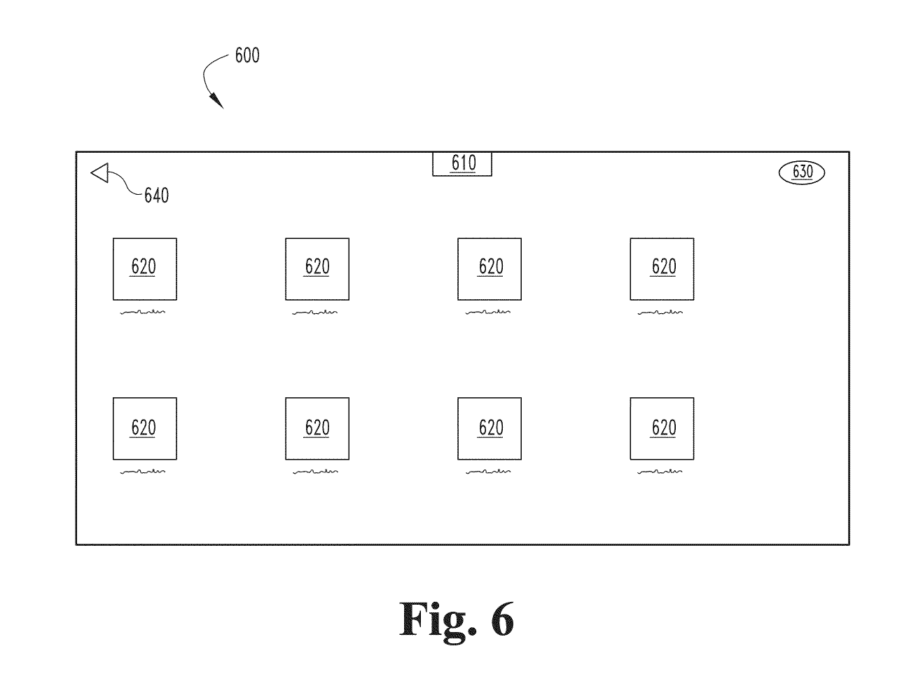

Referring to FIG. 5 in greater detail, there is shown a vertical string of tabs 525, whose titles correspond to either known book or music subgenres. In some implementations, each individual tab can access a database (See FIG. 2); with each subgenre database are two separate databases: the first is a list of all artists and authors that the merged media system has associated with said subgenre, the results of which are shown on a webpage (see FIG. 6) with its own URL—for example, http://www.mergedmediasystem.com/socialhub/rock/indie/allartists; the second database is a list of URL's for websites, each individual website containing one subgenre Wheel 555.

Selecting a particular subgenre tab 525 initiates a search function, causing a search for and display of all URL's in the subgenre database, with the specific display set for each page to be sized at ¼ normal size, so that four websites are shown per page on the display. In some implementations, the number of Wheels displayed can increase or decrease depending on a number of factors. For example, a smartphone screen with a diagonal size of four inches, or a larger display having a lower native resolution—for instance, 800×600—will not be able to display as many Wheels in a clear manner as a thirty inch, high-resolution—for instance, 2560×1600—will be able to do. Thus, the system can increase or decrease the number of displayed Wheels accordingly to present an optimal viewing environment.

In some other implementations, the Wheel sizes can be individually varied based on a number of factors. For example, if the system determines—for example, by recent searches or the interaction apparatus 170—that a user likes classic rock, the system can increase the diameter of the Wheel representing classic rock and/or increase the number of artists/authors presented on the Wheel. In some further implementations, the system can decrease the diameter of Wheels that the system determines to be less interesting to the user. In continuation of the previous example, if the system determines that the user seems uninterested in hard rock, the system can decrease the size of the Wheel representing hard rock and/or decrease the number of artists/authors presented on the Wheel. Further, the system can perform the above increasing and decreasing Wheel size functions in tandem. For example, increasing the classic rock Wheel can cause all or some of the other displayed Wheels to be proportionally decreased in size to accommodate the increased size of the classic rock Wheel.

Referring to FIG. 5 in greater detail, there is shown two colored tabs separated by a slanted line located above the left-side vertically aligned tabs 525 and to the left of the top-side horizontally aligned tabs 505, and these two buttons 530 refer to toggles that allow the user to choose between viewing genres and subgenres by music associations and book associations.

Referring to FIG. 5 in greater detail, a Search Window 535 allows a user to search for any song, book, artist, author, or Wheel title located anywhere within the website. In some implementations, the search function can be prepopulated with parameters derived from past user actions, past actions of different users that the current user is associated with, current user actions, context of immediate previous searches, and the like.

Referring to FIG. 5 in greater detail, four individual webpages 540 are shown that contains a Wheel and an abbreviated comment section. Each page can be displayed anywhere on the main Social Hub 500 home screen without altering the contents of the page. On each webpage 540 can be found various icons, buttons, windows, tabs, and words, and the page itself has a background design, but is dominated by the outline of the Wheel referenced above.

Referring to FIG. 5 in greater detail, each ¼ sized webpage 540 has a unique URL which is housed within a database belonging to a particular subgenre. The individual pages can be moved around within the main Social Hub 500 home screen in the same way that applications on mobile devices can be rearranged on a particular screen.

Referring to FIG. 5 in greater detail, 545 refers to page markers at the bottom of the Social Hub 500 home screen showing which particular page that the user is viewing out of the total pages of Wheel websites found and displayed when the user selected a genre and then subgenre.

Referring to FIG. 5 in greater detail 555 refers to the main design/shape on each page, which takes the shape of a wheel without spokes. Although there are several features and items on each page displayed by the genre—subgenre search and display function described elsewhere in this application—each webpage 540 is still referred to simply as a Wheel designated by the subgenre within which the user found said Wheel displayed (e.g., an Indie Wheel) or more specifically a particularly placed Wheel on the application interface.

The shape and design consists of concentric lines drawn around the URL's associated with individual artists and authors. (See FIG. 5). In addition, although the concentric lines displayed boldly on each page are simply part of each page's background/art, all other items, buttons, tabs, etc. displayed on the page are referred to as being “in the Wheel” “on the Wheel” “under the Wheel” or “around the Wheel.”

Referring to FIG. 5 in greater detail, 560 refers to an open area at the bottom of the Wheel 555, where the words Meet the Artist/Author 560 or some other words signifying a similar message would be displayed.

The Meet the Artist/Author 560/565 component of the Social Hub allows interaction between artists, authors, and the public. The Meet the Artist/Author 560/565 component allows users to discover artists and material using both a group and an individual dynamic. The group dynamic—for example, discussion boards, Meet the Supporters area 570, general design of the Wheels, etc.—operates by aiding discovery of artists and authors through their inclusion on a Wheel and association with at least one other artist or author who may be known to the user. The individual dynamic operates to allow detailed and personalized discovery by virtue of the authors and artists' individual landing spots, which can incorporate direct artist/author feedback, live chats, and the potential for perks like advance tickets and/or even private concerts, readings, or other events.

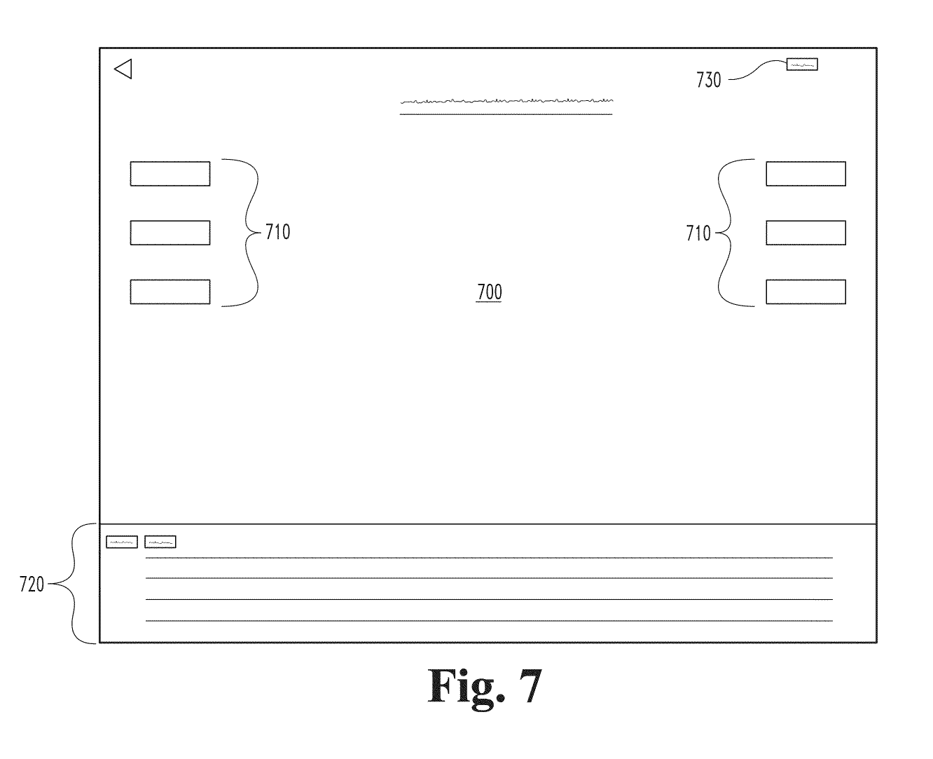

Whatever word or phrase is displayed in the center area of the bottom part of the Wheel 555, corresponding to the area of the wheel where, in some implementations, the words Meet the Artist/Author might appear can constitute a hyperlink that can redirect the user to a webpage (FIG. 6), wherein he or she can view every artist or author currently associated with the merged media system (and having an individual webpage (FIG. 7) and/or merchandize including music/books for purchase or sample), and specifically associated with the particular subgenre of music or books for the Wheel the user was viewing. That is, if the user was viewing a Wheel 555 within the punk-rock subgenre of the rock genre, clocking on a hyperlinked text can redirect the user to a page showing all punk rock authors and artists associated with the merged media system, not only those on the specific punk rock Wheel being viewed—which can be one of several total such Wheels.

Referring to FIG. 5 in greater detail, 565 refers to specific authors or artists names that are arranged in equal spacing around the Wheel within the two concentric lines. If the name is that of an author, it can have a book icon next to the name, and if the name is that of an artist, it can have an album/CD next to the name with a cover from one of said artists' previous albums or songs. In some implementations, if the artist is completely new, he or she can have been prompted to create artwork for an album icon to be placed next to their name on the Wheel.

In some implementations, approximately sixteen total artists and authors can be placed on the Wheel—principally for spacing and aesthetic purposes. A user's cursor-over of a select icon—for devices utilizing cursors—or single touch—in devices integrating touch-screen features—can show a small pop-up rectangular block with brief info about the artist or author such as a mini-biography, or a preview (miniature) of the artist or author's individual webpage. (See FIG. 5). Double-clicking or double-touching a select icon can redirect the user to that artist or author's individual webpage allowing them to Meet the Artist/Author on the Wheel. (FIG. 7).

The authors and artists found on any specific page or Wheel share some commonality. For example, the artist on a specific page can share a commonality between their respective subgenres, have created works that can complement the use or experience of each other if and/or when merged using the application, or have been associated through the historical preferences and actions of previous users. Each author may have been asked to submit, prior to inclusion on Social Hub, a small list or sample of musical artists whose works they believe to be complementary. Prior to inclusion on Social Hub, each artist can be asked to provide a small list or sample of artists who influenced their own work, and already-established artists whose works are similar to their own. The responses can be used as one factor in determining which authors and artists from a particular subgenre were grouped together on a particular Wheel. Examples of other factors include analysis of music styles and lyrics compared to the subject matter of literary works from specific authors, and analysis of ongoing public surveys, and analysis of the results of the application's internal tracking of the music, and the like. Users pair with particular books when utilizing the customization function. Users would be able to influence the pairing of authors and artists on any specific Wheel by using the Add Artist 575 or Add Author 580 functions described herein.

Referring to FIG. 5 in greater detail, the Add Artist 575 or Add Author 580 functions refer to rectangular windows with a dropdown feature, and a very small thumbs up or thumbs down sign beside the window. Add Artist 575 sits above the Meet the Supporters icon (I) which sits in the center of the Wheel, and allows users to suggest artists to include on that particular Wheel by typing the name into the window. Typing a name and hitting the thumbs up button causes that name to be entered into a database. In some implementations, the database is stored on the site under Genre/subgenre/wheel#/newartistssugested where the “newartistssuggested” database has a field that counts each click of the thumbs up button for a particular artist.

If the user decided to enter a name that has already been entered, that name can immediately show up in the dropdown and he or she would simply need to “vote” for the inclusion of that artist by selecting thumbs up. Users can also “vote” to not have artists previously suggested included on the Wheel by viewing all artists suggested (showing in the dropdown) and selecting the thumbs down symbol. Each user must be registered and “signed in” with their unique name and password in order to suggest or vote on new artists, and due to being signed in, can be restricted to one vote per artist.

Restriction is accomplished by including a field in the database referenced above, storing the username of each user submitting a vote—so that the merged media system can track user preferences for artists and authors pairings and offer better mixed Wheels in the future—and prevent the database from accepting another vote for an artist for which a user has already submitted a vote.

Add Author 580 allows users to suggest an author for inclusion on the Wheel, and operates the same way as described for the Add Artist 575 function.

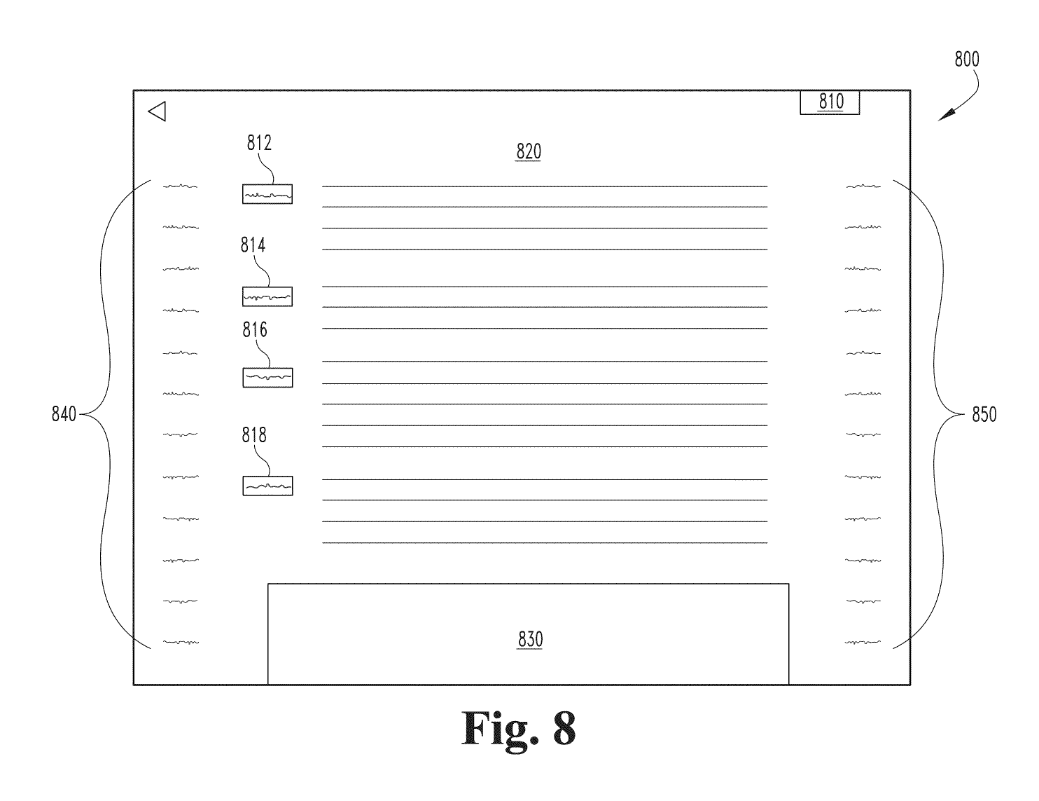

Referring now to the Meet the Supporters 570 section of the page, displayed in the center of the Wheel, the words Meet the Supporters or other words signifying similar meaning would be inscribed. Any words displayed can constitute a hyperlink that can direct the user to a discussion board (FIG. 8) where any registered user can discuss the artists and authors displayed on the particular Wheel he or she were viewing. Selecting Meet the Supporters 570 by double-clicking or double-touching creates an animation wherein the page 540 stretches from its ¼ normal website size to encompass the entire Social Hub home screen 500 and ultimately transforms into the discussion board page previously mentioned (FIG. 8). On the discussion board, users can initiate specific discussion or topic strings that other users can then participate in.

Although any discussion relating to the authors and artists can be initiated, each discussion board can have a few set topics that do not change, and would exist solely for the purpose of enhancing the overall Social Hub experience and providing relevant and important feedback. These set topics are sometimes referred to as “sticky threads.” One such sticky thread can be related to the posting and exchanges between users of custom created lists or recommended Specialty Sound Scores for books belonging to authors being discussed on a particular discussion board. Another sticky thread can be related to concert—and specifically a musicians' set list—feedback, wherein users can request that particular songs be included in the set list at upcoming concerts.

Referring again to FIG. 5 in greater detail, there is shown a small comment section 585 under each Wheel. This comment section shows the last four or five comments posted about that particular Wheel, which can generate interest in the user regarding the ongoing discussions by other users about the artists and authors displayed on the Wheel. To participate in the discussion, the user must first select Meet the Supporters 570.

On the individual landing pages (See FIG. 7), authors will be able to chat about their work process, upcoming books and tours, inspirations; and artists, musicians and bands will be able to promote their music and shows. Some implementations also permit the authors and/or artists to provide samples of their works.

Referring still to FIG. 5 in greater detail, there is shown a small music symbol 590 in the upper-left portion of the page 540, but which can be placed anywhere on the page 540. The symbol is integrated into the subgenre search function, such that selecting the symbol causes it to appear to be highlighted. When highlighted, the URL for the website is treated differently by the database housing it. Typically, each webpage/URL 540 appears in the appropriate subgenre database (See FIG. 2) in the order in which that specific webpage—complete with Wheels and artists, etc.—was created, with the most recently created being at the top of the list in the database, and the first webpage displayed when that subgenre is selected. Selecting the music symbol 590 causes the database to create a subfield of “priority date” for each URL “starred” so that those URLs appear at the top of the list in the database and display in Social Hub in the order that each starred page was created.

Referring still to FIG. 5 in greater detail, an Add to Application Wheels 595 symbol is displayed in the upper-right portion of the page 540, but which can be displayed anywhere on the page 540. The symbol displays a small text box when touched—for touchscreen devices—or when the cursor hovers over the symbol. The text box has the words Add to Application Wheels—or words signifying similar message—within it. The user selecting the symbol adds the particular Wheel—or rather page/URL 540—to the Application Wheels 520 tab, which is located with the main genre tabs 505. This action adds the URL for the particular page 540 into the Application Wheels 520 database. Selecting Application Wheels 520 initiates a search and display function, causing the website to search the contents of the Application Wheels 520 database and display all URL's/webpages 540 found in the order added to the database.

FIG. 6 shows an austere webpage titled Meet the [insert the subgenre name corresponding to the Wheel on which the user clicked in FIG. 5's Meet the Artist/Author 560] Artist/Author 610, with two lines of two-dimensional, rectangular shaped boxes 620 in the body of the page; an oval 630 in the upper right corner of the page, and an arrow 640 in the upper, left corner of the page.

Each rectangular box 620 refers to a miniature or preview of a website belonging to an artist or author from the subgenre listed at the top of the page 610. Every single artist and author related to this subgenre is listed on this page—a kind of a subgenre total roster—by name, shown underneath a miniature/preview of their individual pages that can also be housed on the Social Hub server—and made accessible by clicking directly on the name or preview picture in the Meet the Artist/Author 610 page or by selecting the same artist or author's name or icon from the Wheel on which they're found. The oval 630 refers to a search window, where a user can search for a particular artist or author who did not show up on the first page shown. The arrow 640 refers to a back button that takes the user to the previous screen of the application.

FIG. 7 shows a perspective view of a website 700 with multiple tabs 710 placed on the right and left side of the page, and a comment section 720 at the bottom of the page. Double-clicking on an artist or author's name takes the user to that artist or author's personal webpage hosted on Social Hub. On this page the artist, for example, can offer samples of music, merchandize, or denote when they can be next available for live chat. The center/body of the page can contain any designs or content or information the artist or author wished. Each side tab 710 can link to items or other areas of the merged media system's Marketplace depending on the item. For example, a Samples or Merchandize tabs can take users to the area of the merged media system's Marketplace where one can sample or purchase the selected item.

The comment section of the page 720 can allow users to leave comments—much like on/for online news articles—that the artist or author, or even other fans, can respond to. On certain dates and times, the author or artist can make themselves available for live chats, and the texts of those chats can show up in the comments section 720 at the bottom of the page. In some implementations, at the upper-right corner of the page, can be placed a rectangular window 730 where the user would be prompted to log in if he or she wished to post a comment for the artist or author.

FIG. 8 shows a perspective view of a website 800 with a small rectangular window 810 in the upper-right corner, multiple spaced lines arranged next to a small box-shaped icons 812-818 encompassing the center and most of the web page 820, a comment section at the bottom of the page 830, a sequence of squiggly lines on the right and left edges of the page 840/850. The rectangular window 810 refers to an area where a user can log in to post comments in the comment section 830. Each of the small box-shaped icons refer to chat or discussion topics started by users and to which any other user can add additional comments or respond by selecting the appropriate topic and posting his or her message in the comment box 830. The discussion on the discussion board, to which a user was taken after double-clicking on Meet the Supporters 570 on a particular Wheel, relates to the artists and authors that were found on that particular Wheel—and thus also to a particular subgenre of books and music. The artists and authors that were found on the particular Wheel where a user clicked Meet the Supporters 570 are listed on the discussion board to the left and to the right edges of the webpage, with artists arrayed to the left and authors to the right. Users can go to any of the individual artists' or authors' web pages by selecting their names, which are hyperlinked to their pages through the use of URLs.

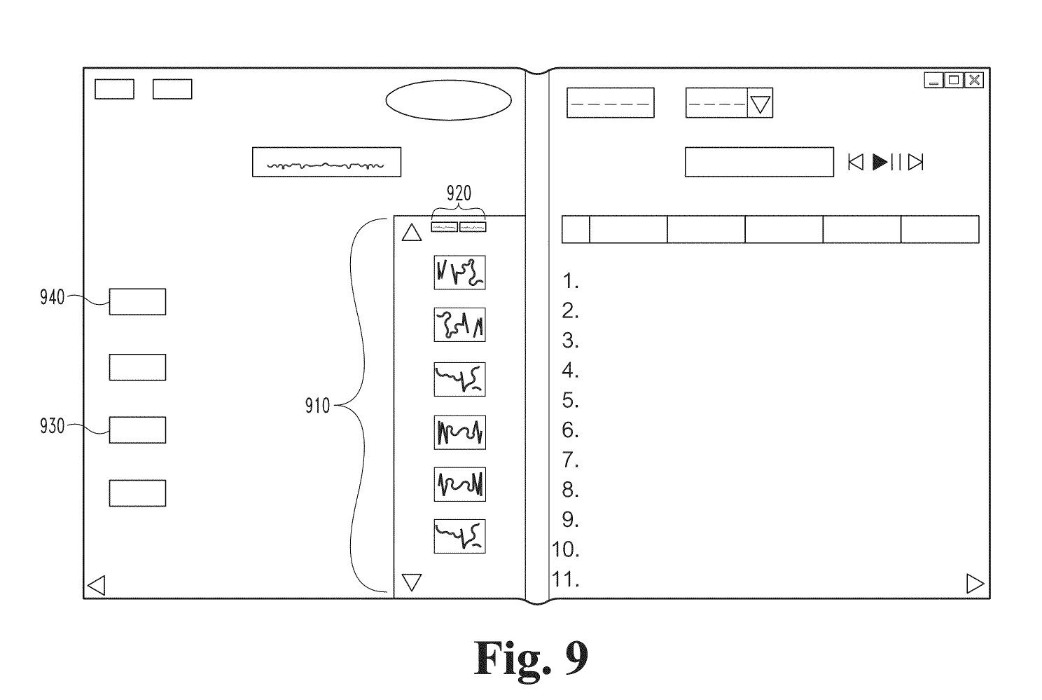

FIG. 9 shows the user interface for the application after a user has selected either LocalMusic 438 or ApplicationMusic 440 from the Main UI 400, signifying a desire to view and/or listen to, or interact with, all music or all music obtained from the merged media system's Marketplace, respectively. Upon selecting either LocalMusic 438 or ApplicationMusic 440, a SlideOut 910 extension of the Music Player contained on the right-half of the application's interface slides out like a tray to the left of the dividing line, at the same height as the Music Player on the right, and approximately ⅕ of the length of the left half of the application. The SlideOut 910 shows music files stored anywhere on available storage (for LocalMusic), and in the ApplicationMusic folder (for ApplicationMusic), arranged by content, album, alphabetically, and the like. The SlideOut 910 enables users to select and interact with content without having to first go through a series of selections in the interface. Further, two toggles 920 at the top of the SlideOut 910 allow a user to view music files by individual song files. Any album or song file can be dragged and dropped into the Music Player on the right side of the application and played from there. Selecting a particular album or song, a user can choose to select it to be inserted in the first available slot in the Music Player by double-clicking the Add tab 930, to the left edge of the application. Clicking the merged media system's Marketplace tab 940 redirects the user to where he or she can engage in various consumer type actions such as purchasing and/or adding new music, which can then be stored either on the device, external storage, or the user's cloud storage, leased as part of a monthly subscription with the merged media system.

FIG. 10 shows an example of one implementation of the user interface for the application after user has selected either LocalBooks 442 or ApplicationBooks 444 from the Main UI 400, signifying a desire to view all books owned or all books obtained from the merged media system Marketplace, respectively. Upon selecting either LocalBooks 442 or ApplicationBooks 444, a SlideOut 1010 extension of the Music Player contained on the right half of the application's interface slides out like a tray to the left of the dividing line, at the same height as the music player on the right, and approximately ⅕ of the length of the left half of the application. The SlideOut 1010 shows all eBooks stored anywhere on available storage (for LocalBooks) and in the ApplicationBooks Folder (for ApplicationBooks). Prior to a book being selected, the Now Viewing Window 418 displays either LocalBooks or ApplicationBooks, and several tabs appear to the left edge of the application, such as Purchase 1020 and Upload 1030.

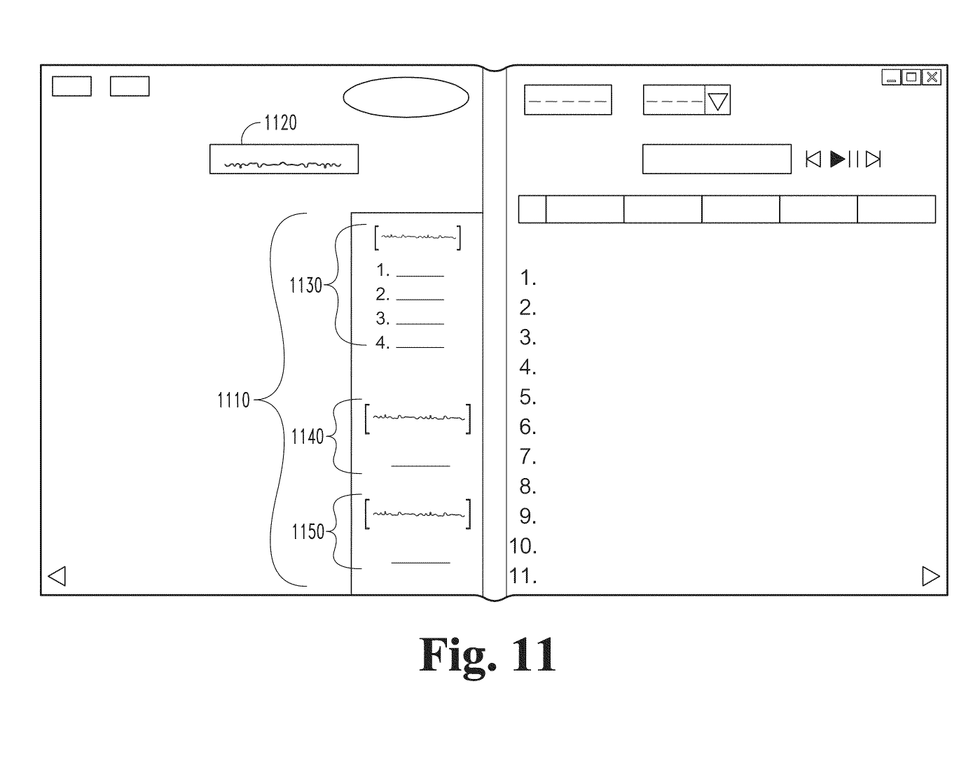

FIG. 11 shows a perspective view of the UI for one implementation application after a user selects a particular book from the SlideOut 1110. The Now Viewing Window 1020 (also 418 in FIG. 4) now displays the name of the selected book, for example, Red Badge of Courage—the book used for instructional purposes in the Manual accessible to the user from the Help portion of the Menu 402. The SlideOut 1110 lists all available scores or soundtracks or special music lists associated with the particular selected book (all such music files being saved to the appropriate folder titled by, for example, eBook name). The SlideOut 1110 shows a list of a user's custom-created soundtracks 1030, any available original scores for the selected book 1040, and then any available Specialty Sound Scores for the selected book 1050.

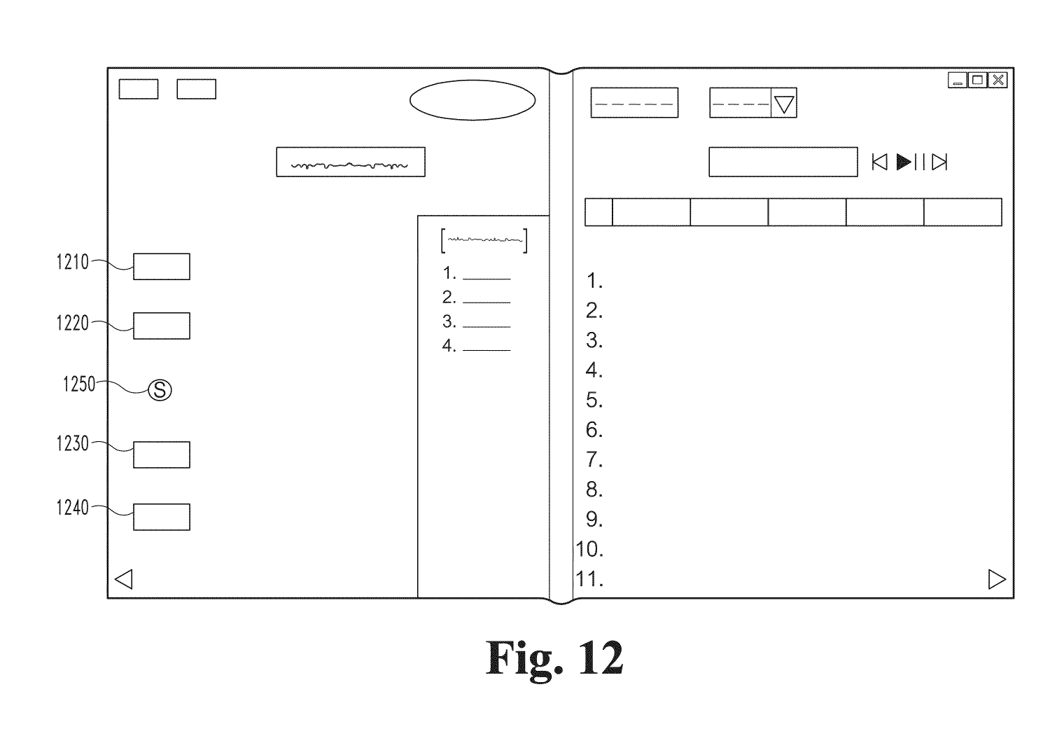

FIG. 12 shows a user selecting a custom score for the selected book. It further illustrates the subtabs and options available for that selection, for example the ability to Create 1210, Edit 1220, Add 1230, or Delete 1240 a custom score, or to request a Syncher 1210 for the book assuming none existed. A Syncher 1210 is some form of association between the eBook and the audio files. For example, the association can be contained within a .txt, .csv, or any other workable method of association. When used by the application, the Syncher can take disparate media—such as a text file and an audio file—and play them as a merged media presentation.

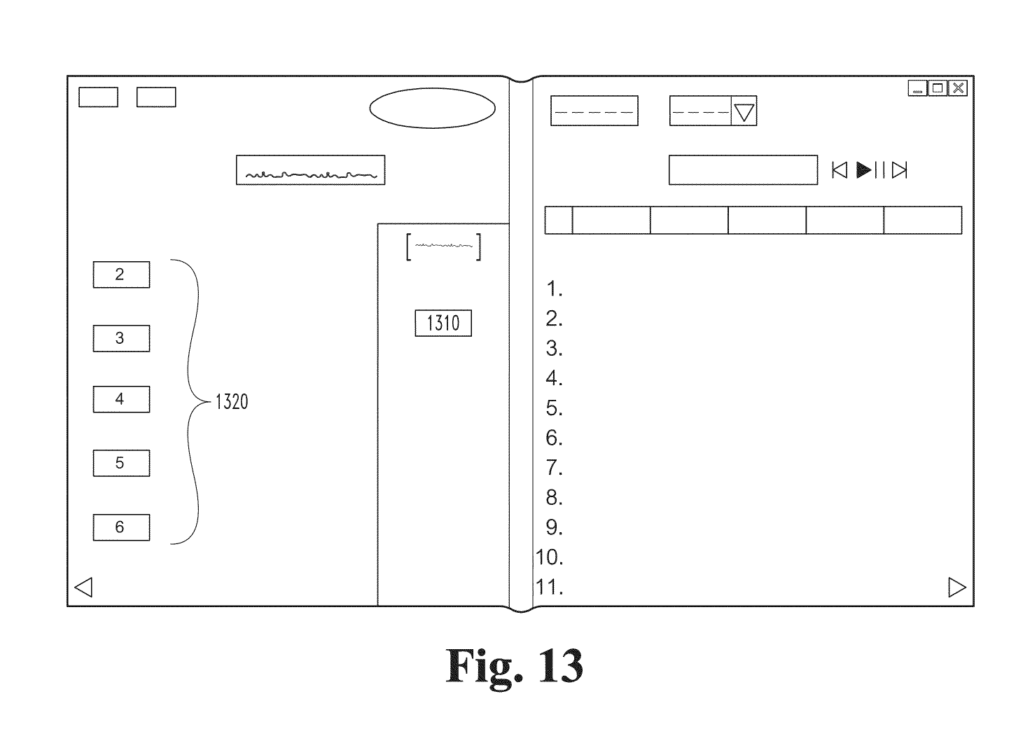

FIG. 13 shows a user selecting a Merged Score 1310 to synchronize with the selected book. It further illustrates the subtabs 1320 and options available for that selection, for example the ability to Purchase an available score if one is not owned.

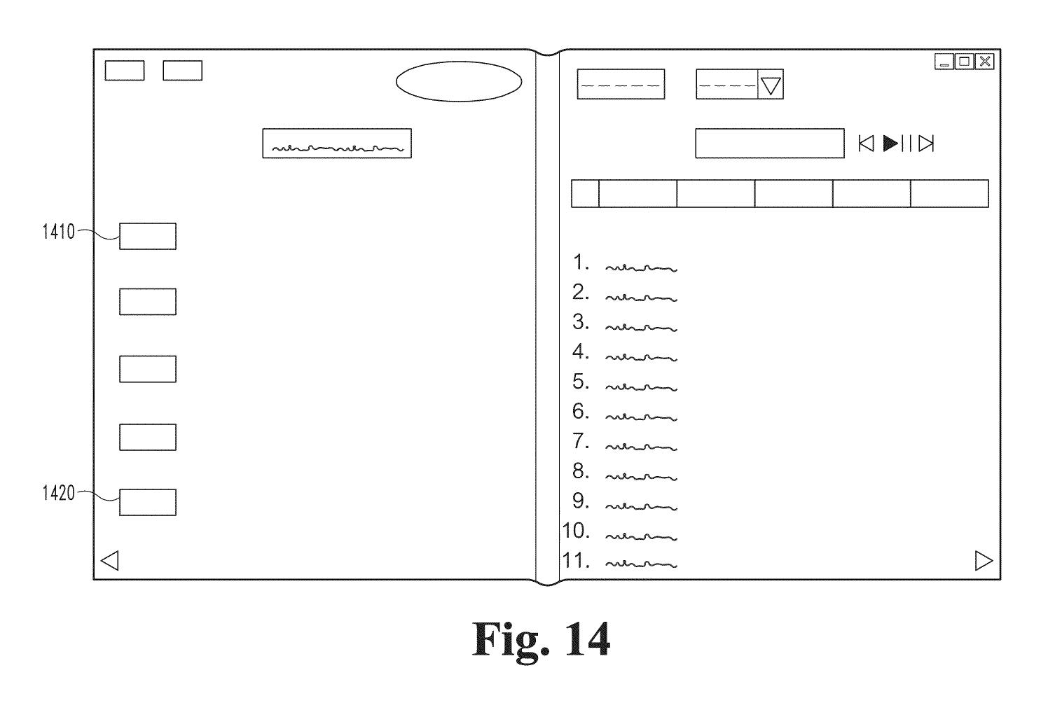

FIG. 14 shows a user selecting a Specialty Sound Score in order to engage in the merged media system's own interactive music match game, discover/purchase new music, and/or create a custom sound score incorporating some or all of the Specialty Sound Score listed songs. It further illustrates the subtabs and options available for that selection, such as the Go function, as well as the Fill, Seek, and Edit functions and the ability to Save created lists.

The Specialty Sound Scores component (also shown 1050 in FIGS. 10 and 446 in FIG. 4) can, and is meant to be, used to download, view, and interact with Sound Scores offered by the application—which can be compilations of Suggested Songs for specific eBooks from New or Emerging Artists. In some implementations, these Sound Scores can be offered for free or for a fee.

The Sound Scores can expose consumers to artists they have potentially never encountered and prompt them to investigate the suggested sample, either by allowing the software application described herein to search consumers' own collection of music for a match to the song or by taking consumers to the linked Social Hub website to listen to a sample of and/or purchase any suggested song. The action can be triggered either by mere curiosity as to why any particular song is included on a list that also includes some known music by known artists or suggested for a particular eBook, or by consumers' competitive desire to own 100 percent of the songs suggested.

Some implementations enable the process of finding and/or purchasing all of the suggested songs in the Sound Score or preferred soundtrack to be incorporated into an Interactive Feature, which can be a competitive experience for users. For example, when the user selects a Specialty Sound Score downloaded for a particular book, for example The Red Badge of Courage, he or she is merely loading a list of song titles, not actual music tracks. However, the application can search the user's available storage areas (including cloud, external or networked storage) to discover how many of the songs suggested on the Specialty Sound Score for playback and synchronization with the Red Badge of Courage are already owned by the user. The user can be found to have anywhere from none to all of the suggested songs, and upon completing the search, the application can do several things, including the following: (1) create links to the actual music files for song titles located in user's storage; (2) indicate songs not found by displaying a special symbol in place of the exclamation point typically shown when a song file in a digital music player is not able to be executed, as well as creating a hyperlink for the song title enabling redirection to an online store for sample or purchase; and/or (3) highlight the results of the search by filling the Now Viewing Window 418 with color to an extent representing the percentage of songs, out of the total suggested in the Specialty Sound Score, that the user was found to possess. In some implementations, the interactive feature of the system can reward interaction volume, frequency, or any other suitable interactive aspect with the system by giving users titles, badges, special icons, better rankings on a user list, and/or many other desirable benefits.

These actions describe another method by which users can create custom Sound Scores for merger with a selected eBook. The user can continue to purchase all of the unfound/unowned tracks, using the now hyperlinked song title to go directly to the area of the online store or the corresponding artist's landing spot where the item can be sampled and/or purchased, until the Specialty Sound Score is filled with executable/playable tracks. Alternatively, users can substitute their own music files for the unowned tracks listed on the Specialty Sound Score.

Note that whatever song the user chooses to drop into slot 10 will immediately be synchronized to the 10^{th} scene in the eBook being read in conjunction with the Sound Score, since any song in that slot will obey the underlying commands for playback described elsewhere in this application. For example, a user adding the desired song into the desired place in the Sound Score from the SlideOut 1010, which slides out and displays all owned songs in all areas, upon user clicking the Fill tab 1410. The SlideOut 1010 retracts when user selects the Accept/Save tab 1420 signifying completion of the customization process and readiness to commence reading the selected eBook accompanied by the music from the Sound Score, which can then play in synchronization.

The above methods provide users with multiple incentives to obtain all of the songs on the Specialty Sound Score that are not already owned, apart from basic competitive inclinations, including the ability to obtain discounted merchandize or subscription credits—or in the case of users who purchase substantial portions of new artists' catalog, to take part in an event involving said artist.

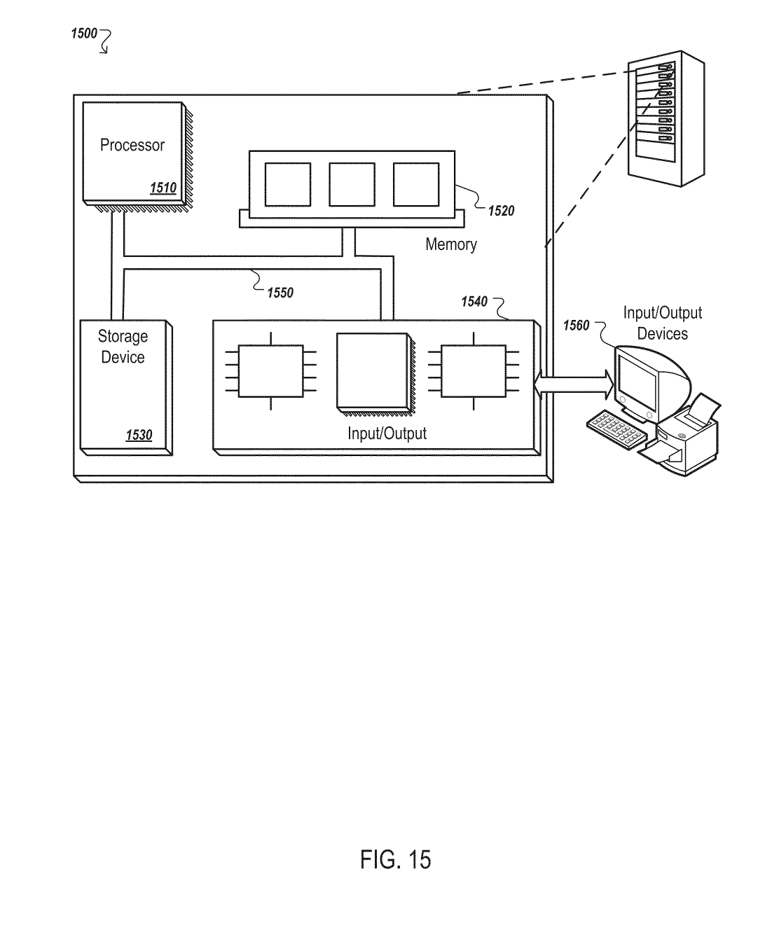

FIG. 15 is a block diagram of an example computer system 1500 that can be used to provide a merged media system and interconnected services, as described above. The system 1500 includes a processor 1510, a memory 1520, a storage device 1530, and an input/output device 1540. Each of the components 1510, 1520, 1530, and 1540 can be interconnected, for example, using a system bus 1550. The processor 1510 is capable of processing instructions for execution within the system 100. In one implementation, the processor 1510 can be a single-threaded processor. In another implementation, the processor 1510 can be a multi-threaded processor. The processor 1510 is capable of processing instructions stored in the memory 1520 or on the storage device 1530.

The memory 1520 stores information within the system 1500. In one implementation, the memory 1520 is a computer-readable medium. In another implementation, the memory 1520 is a volatile memory unit. In yet another implementation, the memory 1520 is a nonvolatile memory unit.

The storage device 1530 is capable of providing mass storage for the system 1500. In one implementation, the storage device 1530 is a computer-readable medium. In various different implementations, the storage device 1530 can include, for example, a hard disk device, an optical disk device, or some other large capacity storage device.

The input/output device 1540 provides input/output operations for the system 1500. In one implementation, the input/output device 1540 can include one or more network interface devices—for example, an Ethernet card—a serial communication device—for example, a RS-232 port—and/or a wireless interface device—for example an IEEE 802.11 card. In another implementation, the input/output device can include driver devices configured to receive input data and send output data to other input/output devices—for example, a keyboard—a printer, and display devices 1560. Other implementations, however, can also be used, such as mobile computing devices, mobile communication devices, set-top box television client devices, etc.

Although an example processing system has been described in FIGS. 1 & 15, implementations of the subject matter and the functional operations described in this specification can be implemented in other types of digital electronic circuitry, or in computer software, firmware, or hardware, including the structures disclosed in this specification and their structural equivalents, or in combinations of one or more of them.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. Method of synchronizing custom sound recordings with eBooks comprising:
receiving, by a computer, a collection of sound scores, each sound score previously synchronized with an eBook, and each sound score comprising at least one audio identifier;
receiving, by a computer, a social similarity weight wherein each social similarity weight is a value representing a social similarity between a first user and a contributing user, and each contributing user having provided one or more sound scores, wherein each provided sound score is a member of the collection of sound scores;
receiving, by the computer, a linear timeline of the eBook, the linear timeline containing points of synchronization;
receiving, from the first user, a progression through the eBook;
synchronizing, by the computer, the progression through the eBook with the linear timeline;
determining, by the computer, whether the first user has progressed to a point of synchronization of the eBook;
upon determining that the first user has progressed to a point of synchronization of the eBook, providing, by the computer, to the first user, a collection of audio identifiers, and each audio identifier is previously associated with the point of synchronization and is a part of a score previously synchronized with the eBook, and each previously synchronized score being a member of the collection of sound scores, wherein each audio identifier is presented in an order, and each audio identifier is ordered by a social similarity weight associated with a contributing user who created the respective sound score; and
receiving, from the first user, an audio identifier to associate with the point of synchronization.

2. The method of claim 1, further comprising:
generating, by the computer, a sound score, the sound score comprising audio identifiers associated with points of synchronization, and each audio identifier received from a contributing user.

3. The method of claim 2, wherein the sound score is associated with a social similarity weight partially based upon the contributing user who created the sound score.

4. The method of claim 2, wherein the generated sound score is automatically generated by the computer.

5. The method of claim 1, wherein the linear timeline of the eBook is generated through the use of optical character recognition technology.

6. The method of claim 1, wherein the first user can select to a point of synchronization by clicking an icon associated with the respective point of synchronization.

7. The method of claim 1, wherein the social similarity weight is partially based upon the first user's reading speed.

8. The method of claim 7, wherein the first user's reading speed can be determined by analyzing ocular interactions while progressing through an eBook.

9. The method of claim 1, wherein an audio identifier can link to resources external to the computer.

10. A system for synchronizing custom sound recordings with eBooks comprising:
at least one user device;
one or more computers operable to interact with the at least one user device; and
a network connecting the at least one user device and the one or more computers;
wherein the one or more computers are further operable to:
receive, by a computer, a collection of sound scores, each sound score previously synchronized with an eBook, and each sound score comprising at least one audio identifier;
receive, by a computer, a social similarity weight wherein each social similarity weight is a value representing a social similarity between a first user and a contributing user, and each contributing user having provided one or more sound scores, wherein each provided sound score is a member of the collection of sound scores;
receive, by the computer, a linear timeline of the eBook, the linear timeline containing points of synchronization;
receive, from the first user, a progression through the eBook;
synchronize, by the computer, the progression through the eBook with the linear timeline;
determine, by the computer, whether the first user has progressed to a point of synchronization of the eBook;
upon determining that the first user has progressed to a point of synchronization of the eBook, provide, by the computer, to the first user, a collection of audio identifiers, and each audio identifier is previously associated with the point of synchronization and is a part of a score previously synchronized the eBook, and each previously synchronized score being a member of the collection of sound scores, wherein each audio identifier is presented in an order, and each audio identifier is ordered by a social similarity weight associated with a contributing user who created the respective sound score; and
receive, from the first user, an audio identifier to associate with the point of synchronization.

11. The system of claim 10, further comprising:
generating, by the computer, a sound score, the sound score comprising audio identifiers associated with points of synchronization, and each audio identifier received from a contributing user.

12. The system of claim 11, wherein the sound score can be associated with a social similarity weight partially based upon a contributing user who created the sound score.

13. The system of claim 11, wherein the generated sound score can be automatically generated by the computer.

14. The system of claim 10, wherein the linear timeline of the eBook is generated through the use of optical character recognition technology.

15. The system of claim 10, wherein the first user can select a point of synchronization by clicking an icon associated with the respective point of synchronization.

16. The system of claim 10, wherein the social similarity weight is partially based upon a user's reading speed.

17. The system of claim 16, wherein the user's reading speed is partially derived from an analysis of ocular interactions while progressing through the eBook.

18. The system of claim 10, wherein the one or more computers are further operable to:
receive, from the computer, user interaction information from a third-party program wherein the information transfer from a third-party party program is depicted through the use of a sidebar

19. The system of claim 10, wherein an audio identifier can link to resources external to the computer.
